(19) United States
(12) Patent Application Publication
(10) Pub. No.: US 2025/0232008 A1
(43) Pub. Date: Jul. 17, 2025

(54) SYSTEMS AND METHODS FOR FACILITATING ANALYSIS OF DIMENSIONALITY-REDUCED DATA

(71) Applicant: Intuitive Research and Technology Corporation, Huntsville, AL (US)

(72) Inventors: Connor Clement GREEN, Madison, AL (US); Kyle John CAMLIC, Huntsville, AL (US); Connor Hamilton BAUGH, Orlando, FL (US); Eric Arash AHMADI, Madison, AL (US); Kyle Jordan RUSSELL, Huntsville, AL (US)

(21) Appl. No.: 18/951,398

(22) Filed: Nov. 18, 2024

Related U.S. Application Data
(60) Provisional application No. 63/621,382, filed on Jan. 16, 2024.

(51) Int. Cl. G06F 18/2137; G06F 18/2433

(52) U.S. Cl. CPC G06F 18/21375; G06F 18/2433

(57) ABSTRACT

A system for facilitating analysis of dimensionality-reduced data is configurable to: (i) access an input dataset; (ii) generate a plurality of dimensionality-reduced datasets based on the input dataset; (iii) for each particular dimensionality-reduced dataset: generate one or more digital signals and apply digital signal processing to determine one or more relevance scores for the particular dimensionality-reduced dataset; and (iv) (a) generate a report based on the one or more relevance scores associated with each particular dimensionality-reduced dataset or (b) present at least a set of dimensionality-reduced datasets of the plurality of dimensionality-reduced datasets on a user interface, wherein the set of dimensionality-reduced datasets is selected based on the one or more relevance scores associated with the set of dimensionality-reduced datasets satisfying one or more conditions.

### CROSS-REFERENCE TO RELATED APPLICATIONS

This application claims priority to U.S. Provisional Patent Application No. 63/621,382, filed on Jan. 16, 2024, and entitled “SYSTEMS AND METHODS FOR FACILITATING ANALYSIS OF DIMENSIONALITY-REDUCED DATA”, the entirety of which is incorporated herein by reference for all purposes.

### BACKGROUND

With recent technological advancements, electronic storage of data is ubiquitous and readily utilizable by individuals and enterprises/organizations. The accessibility/usability of electronic data storage has given rise to the acquisition of voluminous bodies of electronically stored data in various contexts (e.g., sensor data, event/log data, transaction data, and/or other types of data). Such data can be acquired for various purposes, such as diagnostic, monitoring, interventive, and/or other purposes in various domains (e.g., mechanical, medical, security, research, commercial, and/or other domains).

Such voluminous stores of data have the potential to be utilized to provide various insights that may be valuable to various entities. However, interpreting and/or acting upon such large quantities of data is associated with many challenges, such as being time-consuming, complex, susceptible to errors, etc.

The subject matter claimed herein is not limited to embodiments that solve any challenges or that operate only in environments such as those described above. Rather, this background is only provided to illustrate one exemplary technology area where some embodiments described herein may be practiced.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example dataset that includes synthetic data for an organization.

FIG. 2 illustrates an example data analysis interface that provides a 3D representation of an input dataset.

FIG. 3 illustrates example aspects of a data analysis system, in accordance with implementations of the present disclosure.

FIG. 4 illustrates an example 2D image of a cluster of points of a 3D representation, a signal generated based on the 2D image, and a signal-to-noise ratio generated based on a fast Fourier transform of the signal.

FIG. 5 illustrates an example of signal-to-noise ratio characteristics of a signal generated based on a point cluster of a dimensionality-reduced representation that includes random noise.

FIGS. 6-11 illustrate examples of additional signal-to-noise ratio characteristics of signals generated based on point clusters of dimensionality-reduced representations that include patterns.

FIG. 12 illustrates example aspects of a data analysis system, in accordance with implementations of the present disclosure.

FIG. 13A illustrates an example representation of a dimensionality-reduced dataset.

FIG. 13B illustrates a kernel density estimation plot of spatial autocorrelation values associated with the dimensionality-reduced dataset shown in FIG. 13A.

FIG. 13C illustrates a kernel density estimation plot of spatial autocorrelation values associated with a permutated dataset based on the dimensionality-reduced dataset shown in FIG. 13A.

FIG. 14A illustrates an example representation of a dimensionality-reduced dataset.

FIG. 14B illustrates a kernel density estimation plot of spatial autocorrelation values associated with the dimensionality-reduced dataset shown in FIG. 14A.

FIG. 14C illustrates a kernel density estimation plot of spatial autocorrelation values associated with a permutated dataset based on the dimensionality-reduced dataset shown in FIG. 14A.

FIG. 15A illustrates an example representation of a dimensionality-reduced dataset.

FIG. 15B illustrates a kernel density estimation plot of spatial autocorrelation values associated with the dimensionality-reduced dataset shown in FIG. 15A.

FIG. 15C illustrates a kernel density estimation plot of spatial autocorrelation values associated with a permutated dataset based on the dimensionality-reduced dataset shown in FIG. 15A.

FIG. 16 illustrates a conceptual example of multiple dimensionality-reduced datasets generated using different parameters.

FIGS. 17, 18, and 19 illustrate example flow diagrams depicting acts associated with facilitating analysis of dimensionality-reduced data.

FIG. 20 illustrates an example system that may comprise or implement one or more disclosed embodiments.

### DETAILED DESCRIPTION

Disclosed embodiments are directed to systems, methods, devices, and/or techniques for facilitating analysis of dimensionality-reduced data.

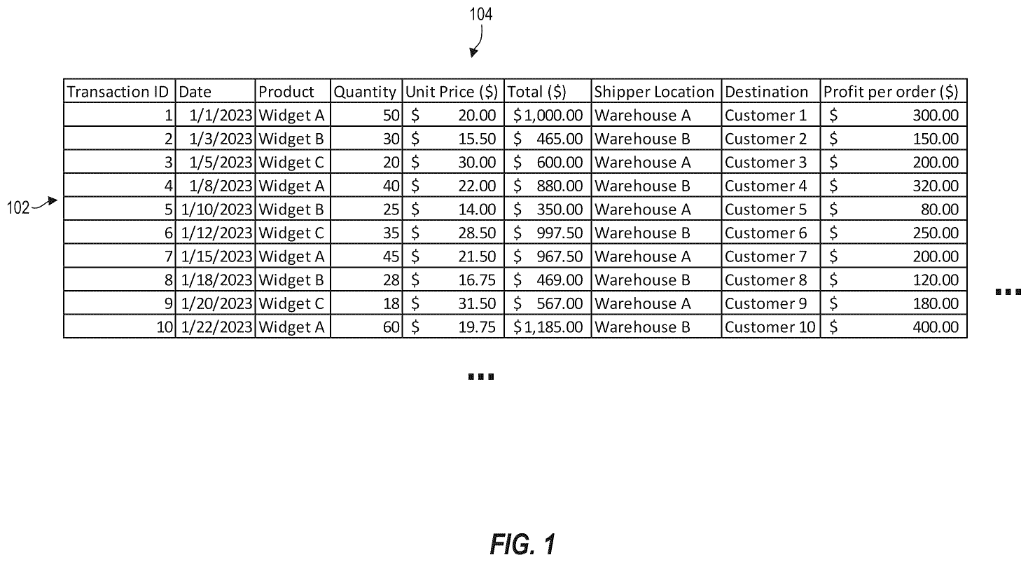

FIG. 1 provides an example dataset 100 that includes synthetic sales data for an organization, which will be referred to throughout this description for illustrative purposes. The example dataset 100 includes various data entries 102 represented as lines, with the different dimensions 104 of each data entry 102 being represented as columns. Although lines and columns are used to represent the data entries 102 and dimensions 104 of such elements, other organizational structures are within the scope of the present disclosure. The ellipses in FIG. 1 indicate that an example dataset 100 of an organization/entity can include any quantity of data entries and/or dimensions, and any quantity of datasets can be stored in association with an organization/entity.

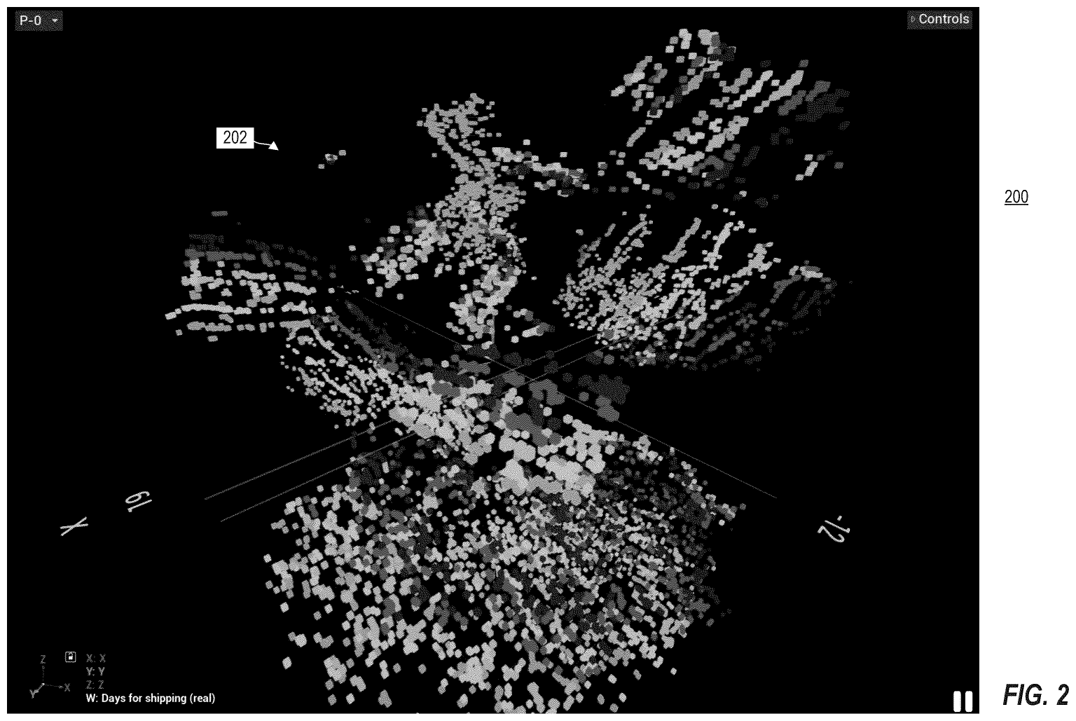

As noted above, interacting with and/or acting upon large bodies of stored data (e.g., sensor data, event/log data, transaction data, and/or others) is associated with many challenges. Consequently, although entities and/or organizations often store voluminous data pursuant to their operations (e.g., in a form conceptually similar to the example dataset 100), such entities and/or organizations typically fail to draw beneficial inferences, relationships, and/or correlations from such data. Various tools have been developed to assist data scientists in interpreting large bodies of data (e.g., to identify trends, relationships, and/or correlations among variables within the data). For instance, FIG. 2 illustrates an example data analysis interface 200 that provides a 3D representation 202 of data. The 3D representation 202 can be generated based on data from a dataset (e.g., conceptually similar to the example dataset 100). For instance, an input dataset may be utilized as input to a dimensionality reduction module that can facilitate data visualization in three dimensions, such as, by way of non-limiting example, UMAP (uniform manifold approximation and projection), t-SNE (t-distributed stochastic neighbor embedding), principal component analysis (PCA), isometric mapping, multi-dimensional scaling (MDS), autoencoders, Laplacian eigenmaps, and/or other artificial intelligence and/or machine learning based techniques.

In some implementations, the 3D representation 202 can be conceptualized as a point cloud generated based on the input dataset that visualizes each data entry (e.g., conceptually similar to data entries 102) of the input dataset as a point in the point cloud (e.g., where the values in the dimensions/columns of a data entry are considered as a whole to inform placement of the point corresponding to the data entry within the point cloud). The 3D representation 202 of the input data can enable users to interact with the input data in an intuitive manner, such as by changing viewing orientation, zooming, panning, etc. In some implementations, the data analysis interface 200 can enable colorization (or other visual emphasis) of points of the 3D representation 202 based on dimensions (or columns) associated with the input dataset. For instance, the data analysis interface 200 may be configured to receive input selecting one or more dimensions (or columns) of the input dataset, which can cause the data analysis interface 200 to colorize points of the 3D representation 202 based on the values in the selected dimension(s) of the data entries associated with the points.

By way of illustrative example, if the 3D representation 202 were generated based on the example dataset 100, a user may select the “Product” column as a basis for colorization within the data analysis interface 200, which can cause points of the 3D representation 202 to take on different colors based on the values in the “Product” column of the data entries 102 upon which the points in the 3D representation 202 are based. For instance, points associated with data entries 102 that have the value “Widget A” in the “Product” column in the example dataset 100 can be assigned the color blue, whereas points associated with data entries 102 that have the value “Widget B” in the “Product” column in the example dataset 100 can be assigned the color red, and a different color can be used for points associated with the “Widget C” value, so on.

The user may selectively toggle between different colorization bases (e.g., different dimensions/columns from the input dataset) within the data analysis interface 200 to develop an understanding of potential relationships or correlations between variables within the input dataset, which can give rise to further statistical analysis on the input dataset.

Although the foregoing techniques (e.g., utilizing a data analysis interface 200 with colorization or visual emphasis functionality) can assist users in developing an understanding of potential relationships or correlations within large datasets, such techniques are associated with various challenges. For instance, the dimensionality reduction module used to process an input dataset to generate a 3D representation 202 for analysis via a data analysis interface 200 can be non-deterministic or highly affected by changes in parameters. By way of example, a UMAP module usable to generate a 3D representation 202 based on an input dataset can have numerous parameters, such as “n_neighbors”, “n_components”, “min_dist”, “spread”, “local_connectivity”, “negative_sample_rate”, “transform_queue_size”, and/or others. Small variations in such parameters can result in large variations in the visual, structural, and/or organizational characteristics of the resulting 3D representation. Thus, different parameter values for dimensionality reduction modules used to generate 3D representations of input data can give rise to numerous different 3D representations based on the same input dataset.

Different 3D representations generated using different dimensionality reduction module parameters can have varying degrees of usefulness to users for identifying potential correlations or relationships within the input dataset. Consequently, users often rely on a trial-and-error approach, experimenting with different dimensionality reduction module parameters to generate different 3D representations based on input data to determine which parameters yield particularly useful 3D representations for data interpretation. Because of the variation in input datasets, parameter values that can facilitate generation of beneficially interpretable 3D representations for one input dataset are not always usable for generation of beneficially interpretable 3D representations for another input dataset (e.g., different datasets can have different dimensions and/or dimension types, such as different quantities of categorical vs numerical dimensions). Accordingly, a trial-and-error approach to determine appropriate dimensionality reduction module parameters (often dataset-specific parameters) can be cumbersome, time-consuming, inefficient, inaccurate, and/or otherwise disadvantageous.

At least some disclosed embodiments are directed to implementing a relevance scoring framework for 3D representations generated based on input datasets, which can indicate the potential usefulness of 3D representations to users for identifying relationships or correlations among variables of the input datasets. For instance, a system may utilize a dimensionality reduction module (e.g., UMAP or others) to process an input dataset to generate multiple 3D representations (or dimensionality-reduced datasets) based on the same input dataset. Each of the multiple 3D representations can be generated using at least slightly varying parameter values for the dimensionality reduction module, which can cause each of the multiple 3D representations to have at least slightly varying characteristics or attributes. The system may additionally process each of the multiple 3D representations according to the relevance scoring framework to determine one or more relevance scores for the 3D representations (or for components of the 3D representations, such as point clusters). Processing the multiple 3D representations according to the relevance scoring framework can include converting each of the multiple 3D representations (or components/data thereof) into one or more signals and processing the signal(s) using digital signal processing (DSP) techniques to determine the relevance score(s). Processing the multiple 3D representations according to the relevance scoring framework can alternatively include generating spatial analysis output using data underlying the 3D representations and applying hypothesis testing to the spatial analysis output using a null hypothesis of spatial randomness. The relevance score(s) for the 3D representations (or components thereof) can enable identification of which particular 3D representation(s) (or components thereof) is/are most likely to be beneficially interpretable by users to identify relationships and/or correlations among the input dataset. For instance, the relevance score(s) can be used to generate a report that identifies particular 3D representation(s) (or components thereof) for further analysis by users. In one example, the system may use the relevance score(s) to generate a sorted list of 3D representations (or components thereof) for presentation to the user, enabling the user to select from among 3D representations (or components thereof) with the highest relevance score(s) for further analysis (e.g., via a data analysis interface 200). As another example, the system can present or enqueue a quantity of 3D representations (or components thereof) based on relevance score(s) (e.g., the 3D representations or components thereof associated with relevance score(s) that satisfy a threshold) for assessment by the user.

The techniques discussed above and hereinafter can be applied to facilitate determination of dataset-specific parameters for dimensionality reduction modules to generate 3D representations of the input dataset that are tailored for user interpretation of correlations and/or relationships among the variables of the input dataset. Although some examples provided herein focus, in at least some respects, on performing dimensionality reduction on datasets to enable generation of 3D representations, one will appreciate, in view of the present disclosure, that dimensionality-reduced datasets can have any quantity of dimensions and can be representable in 2D, 3D, or any other type of visualization. Accordingly, any reference herein to one or more “3D representations” is provided by way of illustration only and is not intended to limit the application of the disclosed principles to implementations that involve reducing input datasets to 3D datasets and/or representations.

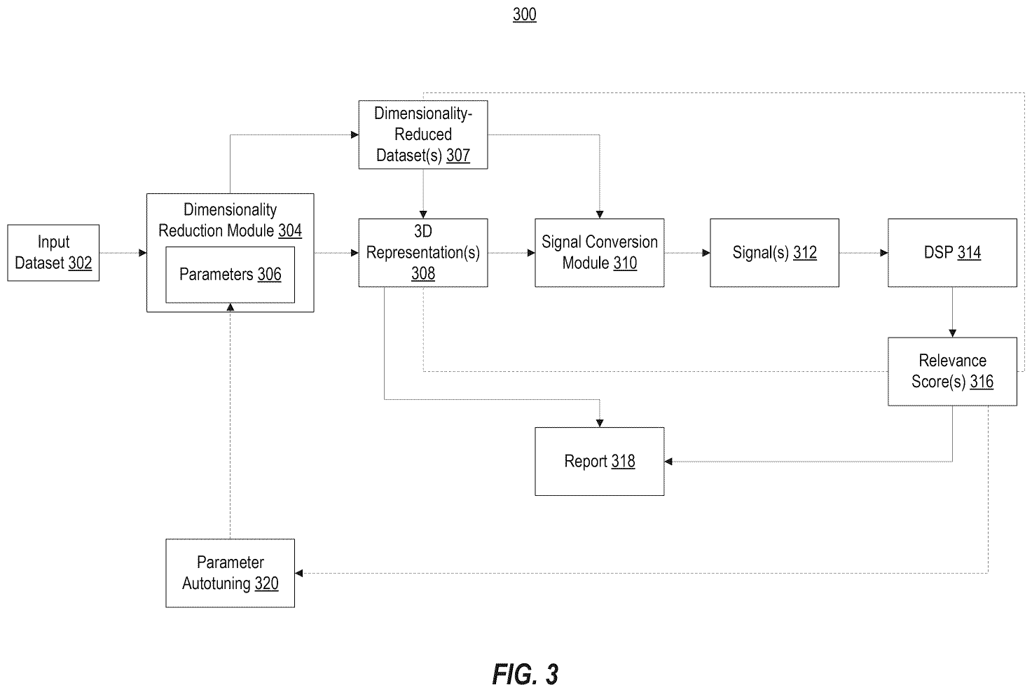

FIG. 3 illustrates example aspects (e.g., inputs, outputs, modules, operations) of a data analysis system 300 that may be utilized to facilitate analysis of dimensionality-reduced data. The various operations described with reference to FIG. 3 may be performed via one or more components of a system 2000 (described hereinafter), and the various data objects, inputs, outputs, and/or modules described with reference to FIG. 3 may be stored on or accessed by one or more components of a system 2000. In particular, FIG. 3 illustrates an input dataset 302, which may conceptually correspond to the example dataset 100 discussed hereinabove with reference to FIG. 1. For instance, the input dataset 302 can comprise data entries (e.g., lines), and each data entry can comprise multiple dimensions (e.g., columns) of data values.

FIG. 3 conceptually depicts processing of the input dataset 302 with a dimensionality reduction module 304, which includes parameters 306. Various types of dimensionality reduction modules 304 are within the scope of the present disclosure, such as, by way of non-limiting example, UMAP, t-SNE, PCA, isometric mapping, MDS, autoencoders, Laplacian eigenmaps, and/or others. In the example of FIG. 3, the dimensionality reduction module 304 outputs dimensionality-reduced dataset(s) 307, which can be used to construct 3D representation(s) 308. The 3D representation(s) 308 can conceptually correspond to the 3D representation 202 discussed hereinabove with reference to FIG. 2. For instance, the 3D representation(s) 308 and/or the dimensionality-reduced dataset(s) 307 can comprise points associated with each data entry of the input dataset 302, with the positioning of each point (e.g., in the 3D representation(s) 308) being influenced by the data values of the corresponding data entry in the various dimensions of the input dataset 302. The 3D representation(s) 308 and/or the dimensionality-reduced dataset(s) 307 can comprise groupings or clusters of points, and the points that form the 3D representation(s) 308 can be colorized or emphasized in different ways (e.g., based on selected data dimension(s)). In some instances, different values associated with the points that form the 3D representation(s) 308 (e.g., values in different dimensions of the dimensionality-reduced dataset(s) 307) can be selected for various operations, such as signal conversions, spatial analysis, score determinations, hypothesis testing, etc. (as will be described in more detail hereinafter).

As noted above, although the examples described with reference to FIG. 3 focus on reducing the input dataset 302 to dimensionality-reduced dataset(s) 307 usable to construct 3D representation(s) 308, dimensionality-reduced dataset(s) 307 can have different quantities of dimensions and/or can be representable in different ways (e.g., 2D, 4D, etc.).

The 3D representation(s) 308 can comprise any quantity of 3D representations, and the dimensionality-reduced dataset(s) 307 can comprise any quantity of dimensionality-reduced datasets, depending on the use case. For instance, the data analysis system 300 can generate multiple dimensionality-reduced datasets 307 and/or 3D representations 308 using the dimensionality reduction module 304 with different sets of parameters 306, which can cause the dimensionality-reduced datasets 307 and/or 3D representations 308 to include different characteristics/attributes (e.g., point positions). The sets of parameters 306 used to generate the different dimensionality-reduced datasets 307 and/or 3D representations 308 can be selected or sampled from a predefined search space (e.g., predefined ranges of parameter values of interest for each of the different parameters 306). For instance, in an example where the dimensionality reduction module 304 comprises a UMAP module, the parameters 306 may comprise “n_neighbors”, “n_components”, “min_dist”, “spread”, “local_connectivity”, “negative_sample_rate”, “transform_queue_size”, and/or others. Each of the dimensionality-reduced datasets 307 and/or 3D representations 308 may be generated using different sets of parameter values with each parameter value being selected from respective parameter value ranges for each of the different parameters. Various sampling or selection techniques may be used to select parameter values for generating different dimensionality-reduced datasets 307 and/or 3D representations 308, such as grid selection, random selection, grid random selection, exhaustive selection, and/or others.

FIG. 3 further conceptually depicts processing the dimensionality-reduced dataset(s) 307 and/or 3D representation(s) 308 with a signal conversion module 310 to obtain signal(s) 312 associated with the dimensionality-reduced dataset(s) 307 and/or 3D representation(s) 308. In the case where multiple dimensionality-reduced datasets 307 and/or 3D representations 308 are included, the signal(s) 312 can include separate sets of signals generated for each of the dimensionality-reduced datasets 307 and/or 3D representations 308. In some instances, for each individual dimensionality-reduced dataset 307 and/or 3D representation 308, the signal(s) 312 include multiple sets of signals, such as where a separate set of signals is generated for each cluster or group of points within each individual dimensionality-reduced dataset 307 and/or 3D representation 308.

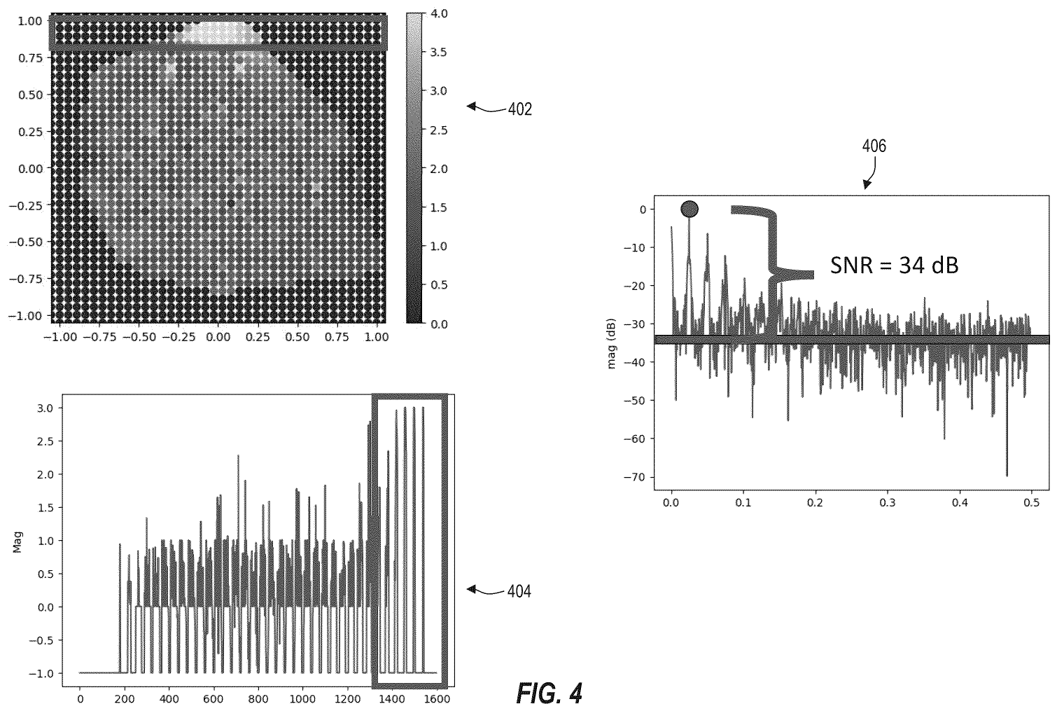

The signal conversion module 310 can implement various techniques to facilitate generation of the signal(s) 312, such as, by way of non-limiting example, raster slicing, projection onto a 2D plane, projection slice theorem, graph/grid conversions/representations, and/or others. By way of illustration, FIG. 4 shows an example 2D image 402 of a cluster of points of a dimensionality-reduced dataset 307 and/or 3D representation 308 generated via operation of a dimensionality reduction module 304 on the input dataset 302. FIG. 4 also provides a conceptual representation of a signal 404 (corresponding to signal(s) 312) generated via raster slicing performed on the cluster of points represented in the 2D image 402. To illustrate the relationship between the signal 404 and the 2D image 402, FIG. 4 shows select portions of the 2D image 402 and the signal 404 that correspond to one another with red boxes (e.g., the portion of the signal 404 bounded with the red box represents the points of the 2D image 402 bounded with the corresponding red box).

The signal 404 of FIG. 4 can comprise an aggregate signal formed from component signals associated with different data values or classes of the points in the 2D image 402. The data values or classes of the points in the 2D image 402 can be associated with one or more selected data dimensions of the data entries associated with the points. In this way, different signals (e.g., signal(s) 312) associated with different data dimensions can be generated for the same point cluster of a dimensionality-reduced dataset 307 and/or 3D representation 308.

As indicated hereinabove, the signal(s) 312 generated via operation of the signal conversion module 310 on the dimensionality-reduced dataset 307 and/or 3D representations 308 (or point clusters thereof) can be amenable to DSP techniques, which can enable acquisition of relevance scores 316 for the various dimensionality-reduced datasets 307 and/or 3D representations 308 (or components thereof). FIG. 3 conceptually depicts performance of DSP 314 on the signal(s) 312, resulting in relevance score(s) 316 for the signal(s) 312. The relevance score(s) 316 can be associated with the dimensionality-reduced dataset(s) 307 and/or 3D representation(s) 308 (or point cluster(s) thereof) that formed the basis of the signal(s) 312 on which the DSP 314 was performed to obtain the relevance score(s) 316 (as indicated in FIG. 3 via the dashed line connecting the relevance score(s) 316 to the dimensionality-reduced dataset(s) 307 and the 3D representation(s) 308). Similar to the signal(s) 312, different relevance score(s) 316 associated with different data dimensions can be generated for the same point cluster of a dimensionality-reduced dataset 307 and/or 3D representation 308.

The DSP 314 can implement various techniques to facilitate generation of the relevance score(s) 316, such as, by way of non-limiting example, fast Fourier transform (FFT), wavelet transform, radon transform, tomography, filtering, and/or other pattern detection techniques. By way of illustration, FIG. 4 shows example output of DSP 314 performed on the signal 404, where the DSP 314 involves applying an FFT to the signal 404 and converting the FFT output to a signal-to-noise ratio (SNR 406), where the highest amplitude peak becomes the reference or “zero” point (emphasized in FIG. 4 with a red dot on the SNR 406). The DSP 314 can further involve detecting the noise floor of the SNR 406, which is conceptually depicted in FIG. 4 with a horizontal red line. The noise floor can be detected using any suitable methods, such as thresholding techniques, wavelet transforms, smoothing, model-based approaches, waveform analysis, etc.

In some implementations, the disparity between the noise floor and the “zero” point (associated with the highest amplitude peak) is used as a basis for determining the relevance score(s) 316. The disparity is indicated in FIG. 4 via a red bracket extending from the noise floor to the zero point on the SNR 406. In some implementations, the disparity is compared to one or more thresholds to determine how the disparity will affect the relevance score(s) 316 for the cluster of points of the 3D representation 308 depicted in the 2D image 402 (which can affect an overall score for the 3D representation 308 of which the cluster of points is a part). In one example, the relevance score(s) 316 for the cluster of points depicted in the 2D image 402, and/or the 3D representation 308 of which the cluster of points is a part, can be increased by a first amount (e.g., +1) if the disparity satisfies a first threshold (e.g., 12 dB), can be increased by a second amount (e.g., +2) if the disparity satisfies a second threshold (e.g., 15 dB), can be increased by a third amount (e.g., +3) if the disparity satisfies a third threshold (e.g., 18 dB), etc. In some instances, relevance scores 316 for individual point clusters of a 3D representation 308 are aggregated to obtain an overall or total relevance score for the 3D representation 308.

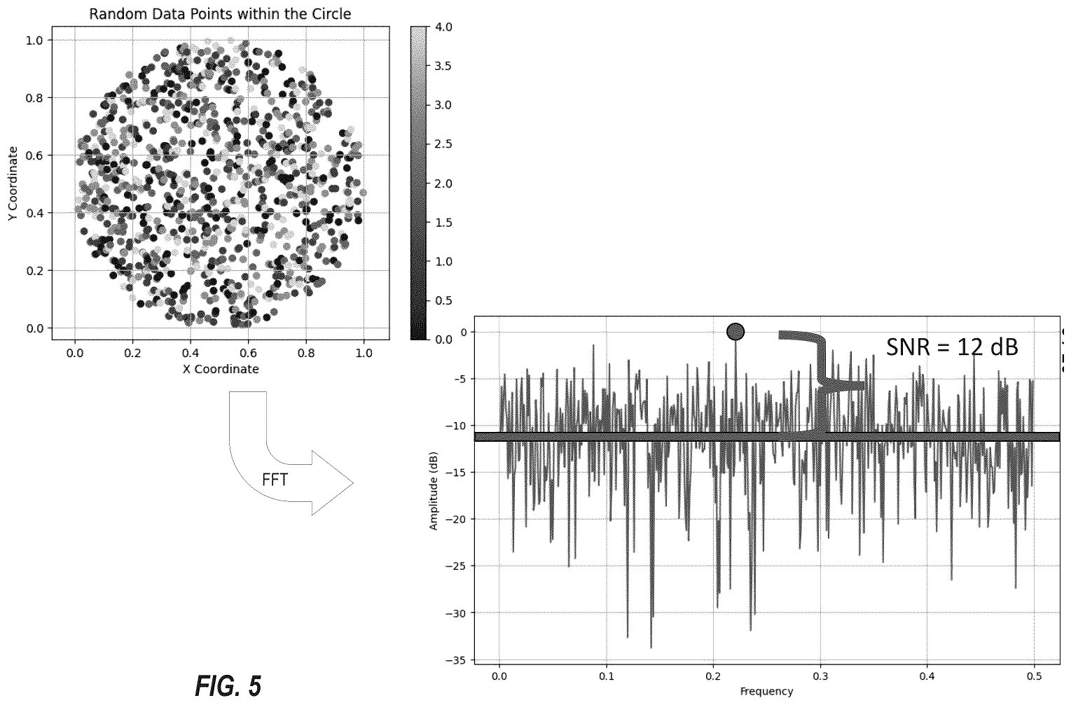

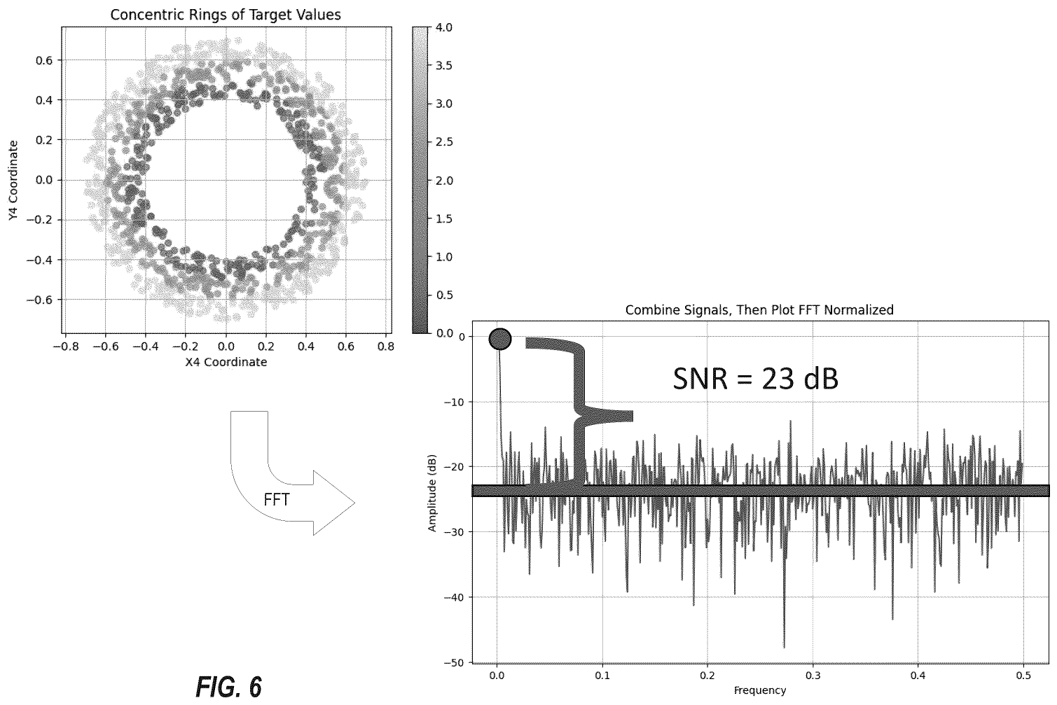

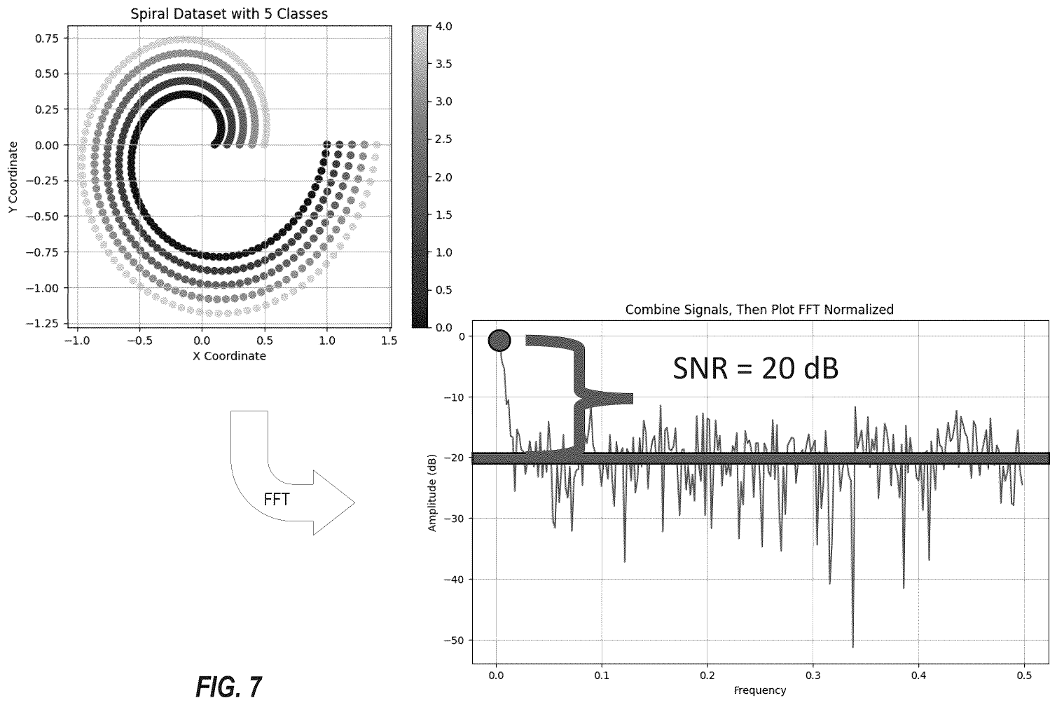

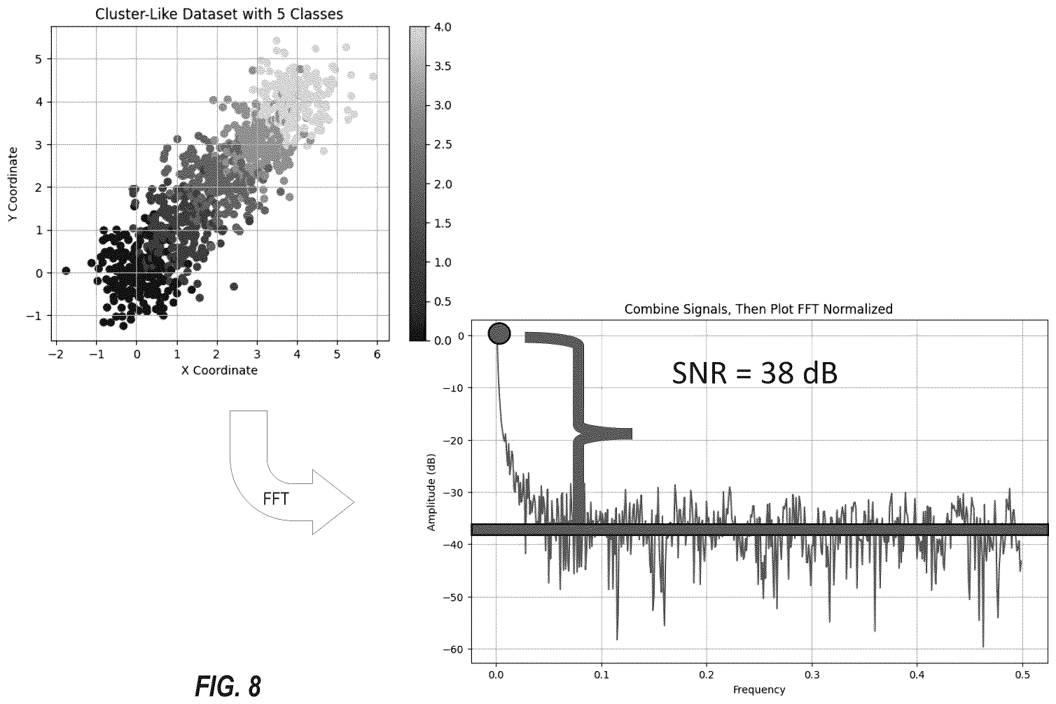

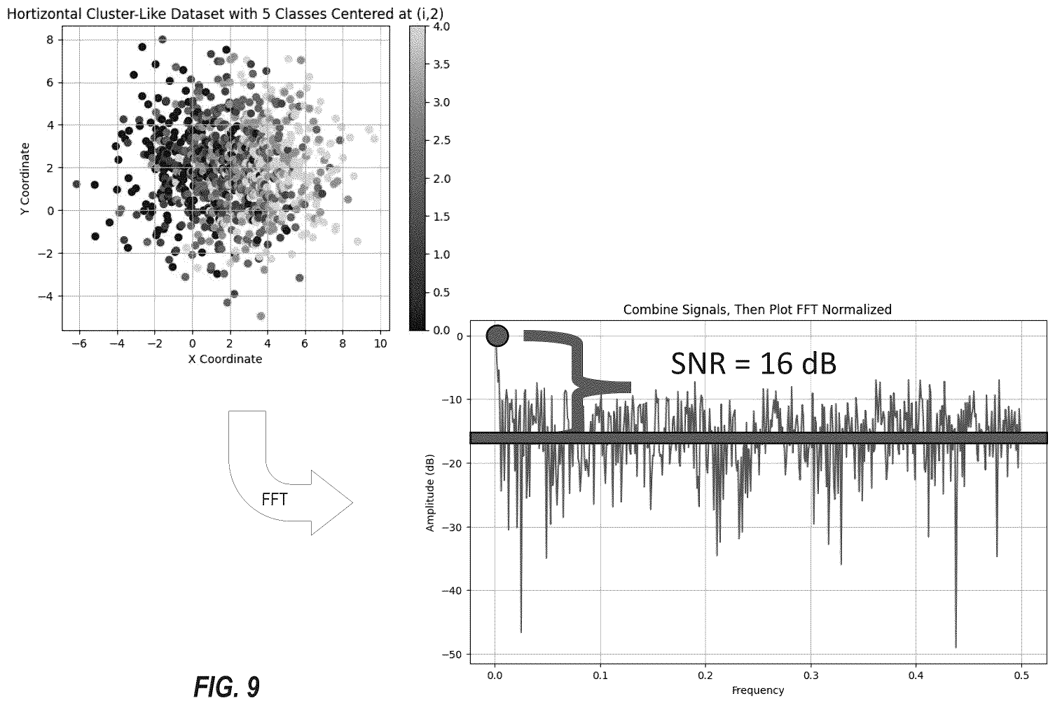

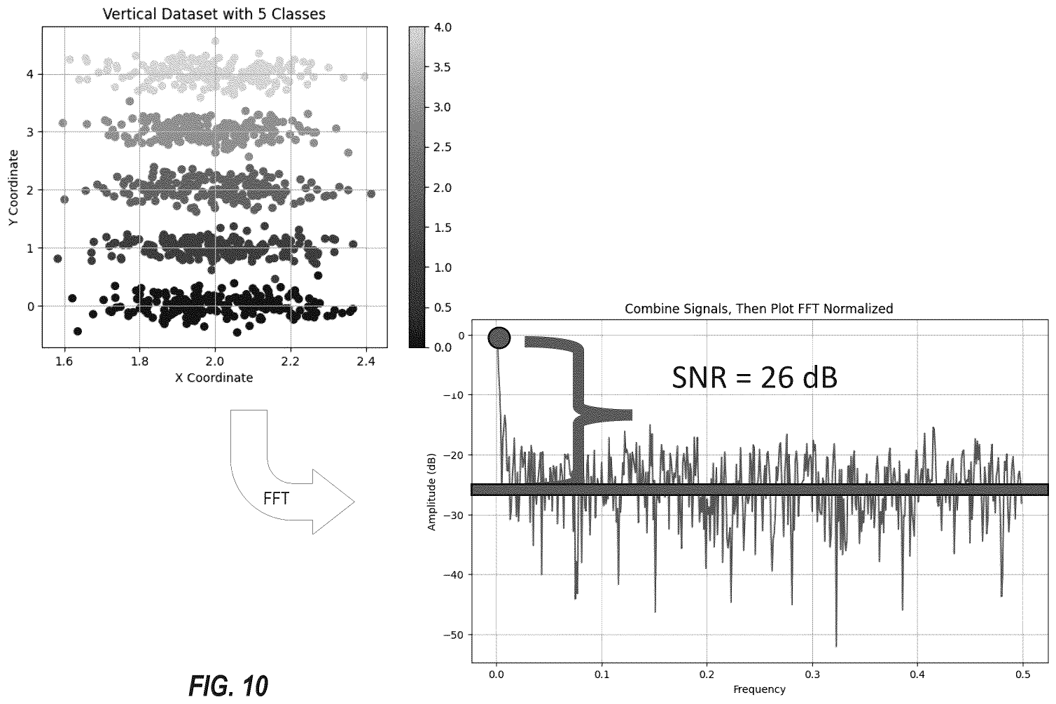

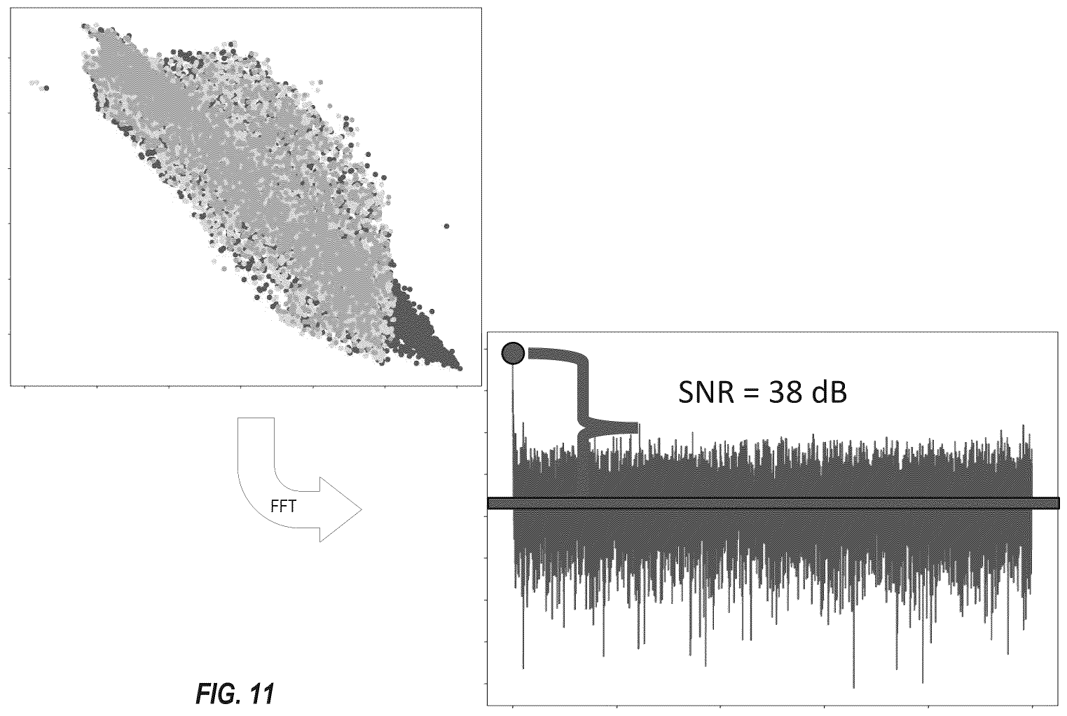

The threshold(s) against which disparity values from SNRs of signals generated based on point clusters of 3D representations can be determined in various ways, such as by evaluating SNR characteristics of signals generated based on point clusters of 3D representations that are irrelevant or unhelpful to correlation/relationship detection by users (e.g., noisy, homogeneous, or micro-anomalous portions of 3D representations). FIG. 5 provides an example of SNR characteristics of a signal generated based on a point cluster of a 3D representation that includes random noise, which is unhelpful to correlation/relationship detection within the underlying input dataset. FIG. 5 shows the disparity between the highest amplitude and the noise floor as 12 dB, indicating that 12 dB may provide a useful threshold disparity against which other disparities may be compared to facilitate calculation of relevance score(s) 316. In some instances, the threshold(s) are at least partially dataset-specific, though some thresholds may be generic across datasets. FIGS. 6-11 provide examples of additional SNR characteristics (e.g., disparities between highest peaks and noise floors) of signals generated based on point clusters of 3D representations, which may be compared against various thresholds to facilitate determination of relevance score(s) 316.

The relevance score(s) 316 for the dimensionality-reduced dataset(s) 307 and/or 3D representation(s) 308 (or for specific point clusters with specific data dimensions selected) can enable identification of which particular dimensionality-reduced dataset(s) 307 and/or 3D representation(s) 308 (or for specific point clusters with specific data dimensions thereof) is/are most likely to be beneficially interpretable by users to identify relationships and/or correlations among the input dataset 302. For instance, the relevance score(s) 316 can provide a basis for generating a report 318 that identifies particular dimensionality-reduced dataset(s) 307 and/or 3D representation(s) 308 (or particular point clusters with specific data dimensions selected) for further analysis by users. In one example, the report 318 comprises a sortable list of dimensionality-reduced datasets 307 and/or 3D representations 308 (or specific point clusters with specific data dimensions selected) that can be presented on a user interface frontend, enabling the user to sort, identify, and/or select dimensionality-reduced datasets 307 and/or 3D representations 308 (or specific point clusters with specific data dimensions selected) with the highest relevance score(s) (overall or cluster-level relevance scores) for further analysis (e.g., via a data analysis interface 200). In some instances, the data analysis system 300 directly loads or identifies dimensionality-reduced datasets 307 and/or 3D representations 308 (or specific point clusters with specific data dimensions selected) within a data analysis interface 200 (or any user interface frontend executable on any device, such as a system 2000) for assessment by the user based on the relevance score(s) 316 (e.g., based on the relevance score(s) 316 satisfying one or more threshold relevance values, which can comprise overall threshold relevance values for entire dimensionality-reduced datasets or 3D representations or point cluster-level threshold relevance values).

In some implementations the parameters 306 used to generate the dimensionality-reduced dataset(s) 307 and/or 3D representation(s) 308 (or point clusters thereof) with relevance score(s) 316 that satisfy the threshold relevance value(s) are utilized to optimize parameters for dimensionality reduction modules for processing of future input datasets. In some implementations, a data analysis system 300 initially processes an input dataset 302 using a dimensionality reduction module 304 with initial parameters 306 to obtain a dimensionality-reduced dataset 307 and/or 3D representation 308, which is then converted into signal(s) 312 and subjected to DSP 314 to obtain relevance score(s) 316. The data analysis system 300 can then analyze the relevance score(s) 316 and perform parameter autotuning 320 (see FIG. 3) to modify the parameters 306 for the dimensionality reduction module 304 to re-process the input dataset 302 to obtain updated relevance score(s) 316. Such a process of generating relevance score(s) 316 and performing parameter autotuning 320 may be iterated until the relevance score(s) 316 satisfy a relevance threshold, at which point a report 318 may be generated for review by a user.

In some implementations, the relevance scoring framework for dimensionality-reduced datasets enables tuning of dimensionality reduction module parameters (or hyperparameters) for generating dimensionality-reduced datasets, which can result in a set of dimensionality-reduced representations for further analysis by users. For instance, a system may initialize a set of parameters for a dimensionality reduction module from a predefined search space utilizing a parameter search module (e.g., grid search, random search, grid random search, Bayesian optimization, genetic algorithms, particle swarm optimization, simulated annealing, metaheuristic optimization algorithms, exhaustive search, and/or others). The system may then generate a set of dimensionality-reduced datasets by processing an input dataset with the dimensionality reduction module using the set of parameters. The system may then convert the set of dimensionality-reduced datasets (or sets of components thereof, such as sets of point clusters) into one or more signals and perform DSP on the signal(s) to determine one or more relevance scores for the set of dimensionality-reduced datasets (or the sets of components thereof). The system may then update the set of parameters for the dimensionality reduction module based on an evaluation of the relevance score(s) for the set of dimensionality-reduced datasets (or the sets of components thereof). The evaluation of the relevance score(s) can take on various forms, such as identifying relevance score(s) that satisfy one or more conditions (e.g., one or more thresholds) and using the identified relevance score(s) as a basis for updating the set of parameters. The system may iterate the steps of generating sets of dimensionality-reduced datasets from the input dataset using the updated set of parameters, converting the sets of dimensionality-reduced datasets into signals, determining relevance scores, and updating the set of parameters based on an evaluation of the relevance scores until a stop condition is satisfied (e.g., performance of a predetermined number of iterations or epochs, detecting performance degradation, plateau detection, detecting relevance score(s) or changes in relevance score(s) with certain characteristics, and/or other conditions). When the stop condition is satisfied, the system can output a set of final parameters for the dimensionality reduction module, which can then be used to process the input dataset to generate a final set of dimensionality-reduced datasets and/or representations (e.g., for use in a report, for presentation on a user interface frontend, etc.).

The examples discussed herein with reference to FIGS. 3 through 11 have focused on implementations in which digital signals are generated based on dimensionality-reduced datasets and digital signal processing is performed on the digital signals to determine relevance scores, which may indicating whether a dimensionality-reduced dataset (or embedding) can provide potentially relevant or interesting/insightful information about aspects, components, relationships, or variables of the underlying input dataset (e.g., from which the dimensionality-reduced datasets were derived). The subject matter of the present disclosure extends to additional techniques for determining relevance scores for dimensionality-reduced datasets, which employ spatial analysis of the dimensionality-reduced dataset coupled with hypothesis testing that uses spatial randomness as a null hypothesis.

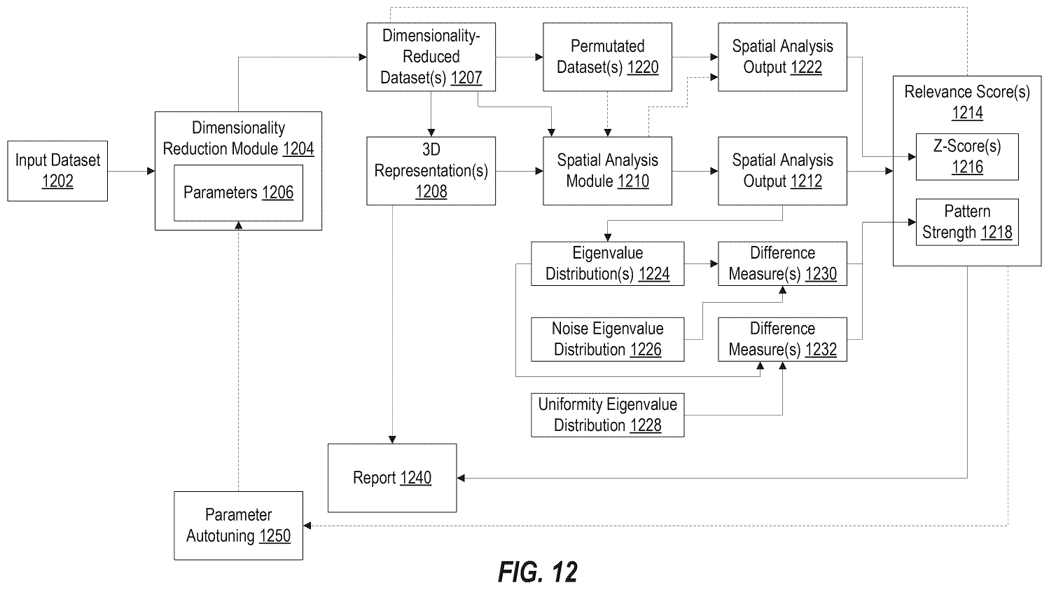

FIG. 12 illustrates example aspects (e.g., inputs, outputs, modules, operations) of a data analysis system 1200 that may be used to facilitate analysis of dimensionality-reduced data. The various operations described with reference to FIG. 12 may be performed via one or more components of a system 2000 (described hereinafter), and the various data objects, inputs, outputs, and/or modules described with reference to FIG. 12 may be stored on or accessed by one or more components of a system 2000. FIG. 12 illustrates an input dataset 1202, which may conceptually correspond to the example dataset 100 discussed hereinabove with reference to FIG. 1. Similar to FIG. 3, FIG. 12 conceptually depicts processing of the input dataset 1202 with a dimensionality reduction module 1204 having parameters 306 (e.g., which may correspond to dimensionality reduction module 304 and parameters 306). For instance, the dimensionality reduction module 1204 may comprise a UMAP module with UMAP parameters. In the example shown in FIG. 12, the dimensionality reduction module 1204 processes the input dataset 1202 and outputs dimensionality-reduced dataset(s) 1207, which can be used to construct 3D representation(s) 1208 (or n-dimensional representation(s); 3D representations are specifically described for the sake of example only). The 3D representation(s) 1208 can conceptually correspond to the 3D representation 202 discussed hereinabove. The dimensionality-reduced dataset(s) 1207 can include any quantity of dimensionality-reduced datasets, which may be generated via the dimensionality reduction module 1204 using different parameters 1206.

The dimensionality-reduced dataset(s) 1207 (and/or the 3D representation(s) 1208) can include groupings or clusters of points, the values or coordinates of which may be used to facilitate spatial analysis and hypothesis testing to determine relevance scores. FIG. 12 conceptually depicts processing of the dimensionality-reduced dataset(s) 1207 and/or the 3D representation(s) 1208 using a spatial analysis module 1210 to obtain spatial analysis output 1212 associated with the dimensionality-reduced dataset(s) 1207 and/or the 3D representation(s) 1208. In some implementations, the spatial analysis module 1210 comprises a spatial autocorrelation module, and different spatial autocorrelation modules can be used depending on the form of the input dataset 1202. In one example, where the input dataset 1202 includes continuous features (or variables with continuous values), the spatial analysis module 1210 used to generate the spatial analysis output 1212 may comprise a Moran's Statistic spatial autocorrelation module. In such cases, the range of values for the spatial analysis output 1212 (e.g., spatial autocorrelation values and/or matrices of values) can be within a range of −1 (indicating dispersion) to 1 (indicating high autocorrelation), with 0 indicating spatial randomness. As another example, where the input dataset 1202 includes categorical features (or variables with categorical values), the spatial analysis module 1210 used to generate the spatial analysis output 1212 may comprise an exact local spatial autocorrelation (ELSA) module. In such cases, the range of values for the spatial analysis output 1212 can be within a range of 0 (indicating high autocorrelation) to 1 (indicating dispersion), with 0.65 indicating spatial randomness.

FIG. 12 conceptually depicts the spatial analysis output 1212 being used as an input to determine relevance score(s) 1214, which may be associated with the dimensionality-reduced dataset(s) 1207 and/or the 3D representation(s) 1208 (similar to the relevance score(s) 316 for the dimensionality-reduced dataset(s) 307 and/or 3D representation(s) 308 discussed hereinabove with reference to FIG. 3). For instance, a separate relevance score 1214 may be determined for each dimensionality-reduced dataset 1207 generated based on the input dataset 1202 via the dimensionality reduction module 1204 (e.g., with different parameters 1206). In the example shown in FIG. 12, the relevance score(s) 1214 is/are determined based on at least two components: z-score(s) 1216 and pattern strength 1218 (or pattern strength metric(s)). As will be described in more detail hereinbelow, the relevance score(s) 1214 may be determined at least in part utilizing hypothesis techniques, where the null hypothesis comprises the dimensionality-reduced being spatially random. As used herein, spatial randomness refers to a dimensionality-reduced dataset (or embedding) being neither clustered nor dispersed, indicating that the information is not organized in any way that would indicate relationships and/or trends among variables of the dimensionality-reduced dataset. Utilizing hypothesis testing techniques to determine the relevance score(s) 1214 can facilitate meaningful assessment of the relevance of a dimensionality-reduced dataset in situations where the dimensionality-reduced dataset manifests high levels of class imbalance and/or data uniformity.

For a particular relevance score 1214 associated with a particular dimensionality-reduced dataset 1207, the particular Z-score 1216 may be determined using the spatial analysis output 1212 (generated based on the given dimensionality-reduced dataset 1207) and additional spatial analysis output. For example, FIG. 12 conceptually depicts permutated dataset(s) 1220, which may be generated by applying permutation operations to the dimensionality-reduced dataset(s) 1207. The permutation operations can comprise (iteratively) randomly relocating the points of the dimensionality-reduced dataset(s) 1207, thereby causing the dataset(s) 1220 to at least partially exhibit or embody spatial randomness. Other permutation techniques may be utilized. The permutated dataset(s) 1220 may include a particular permutated dataset 1220 for the particular dimensionality-reduced dataset 1207 referred to above. FIG. 12 further conceptually depicts additional spatial analysis output 1222 determined using the permutated dataset(s) 1220. The additional spatial analysis output 1222 may be determined using the spatial analysis module 1210, as indicated by the dashed arrows extending from the permutated dataset(s) 1220 to the spatial analysis module 1210 and toward the additional spatial analysis output 1222. In some instances, the additional spatial analysis output 1222 is generated using different modules/processes than the spatial analysis module 1210 used to generate the spatial analysis output 1212. Continuing with the above example, the particular Z-score 1216 (for the particular dimensionality-reduced dataset 1207) may be generated using corresponding spatial analysis output 1212 (generated via spatial analysis on the particular dimensionality-reduced dataset 1207) and corresponding additional spatial analysis output 1222 (e.g., generated via spatial analysis on the particular permutated dataset 1220 derived from the particular dimensionality-reduced dataset 1207). By way of illustrative example, the particular Z-score 1216 for the particular dimensionality-reduced dataset 1207 may be defined using (i) spatial autocorrelation values from the corresponding spatial analysis output 1212, (ii) a mean spatial autocorrelation value from the corresponding additional spatial analysis output 1222, and (iii) a standard deviation spatial autocorrelation value from the corresponding additional spatial analysis output 1222, such as by:

$$Z = \frac{x - μ}{σ} \qquad ( 1 )$$

where Z represents the particular Z-score 1216, x represents a spatial autocorrelation value from the spatial analysis output 1212, μ represents a mean spatial autocorrelation value from the additional spatial analysis output 1222, and σ represents a standard deviation spatial autocorrelation value from the additional spatial analysis output 1222. In this regard, the Z-score(s) 1216 for the relevance score(s) 1214 may be obtained under the null hypothesis of spatial randomness.

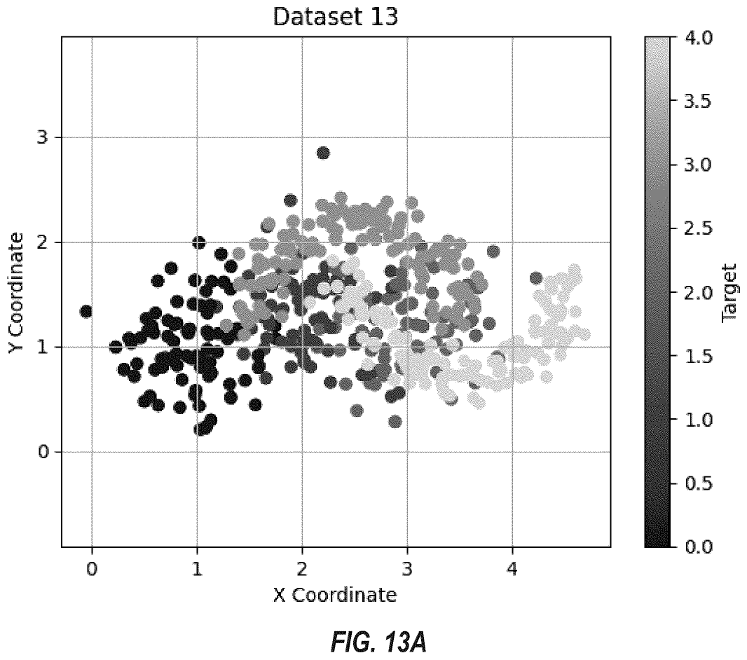

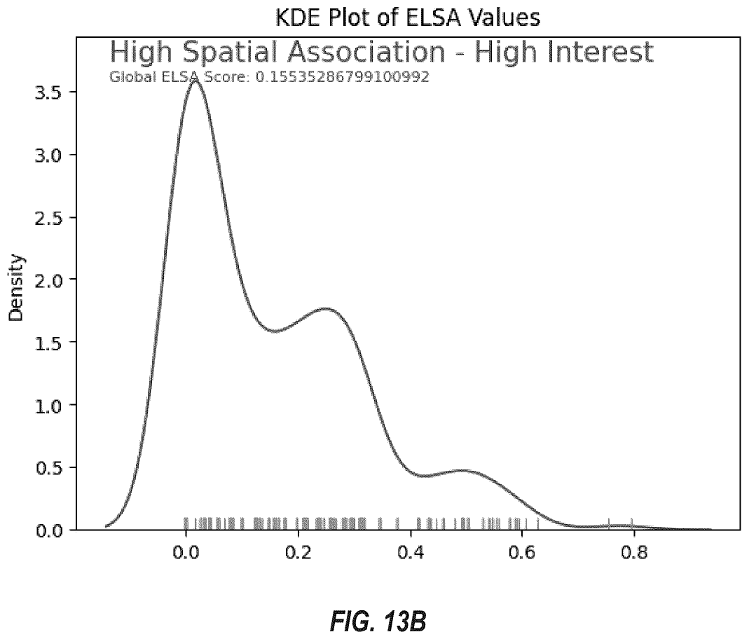

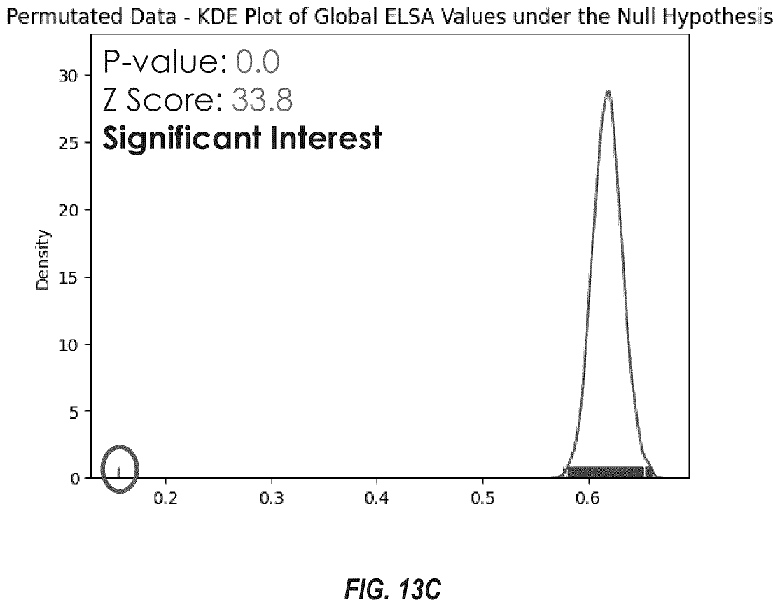

FIG. 13A illustrates a 2D representation of an example dimensionality-reduced dataset (labeled “Dataset 13”), with the colors of the various points indicating different categories. FIG. 13B illustrates a kernel density estimation (KDE) plot of the spatial autocorrelation values associated with Dataset 13. FIG. 13B indicates that the global spatial autocorrelation score for Dataset 13 is 0.15535286799100992, which indicates that Dataset 13 is likely relevant (e.g., has a high tendency to exhibit, communicate, or emphasize data trends/relationships). FIG. 13C illustrates a KDE plot of spatial autocorrelation values associated with a permutated dataset based on Dataset 13. FIG. 13C plots the global spatial autocorrelation score for Dataset 13 (with a red marker and circle), illustrating the disparity between the global spatial autocorrelation score for Dataset 13 and the mean of the spatial autocorrelation values for the permutated dataset based on Dataset 13. FIG. 13C also indicates the Z-score of 33.8 for Dataset 13 (e.g., corresponding to Z-score(s) 1216), also indicating that Dataset 13 is likely relevant.

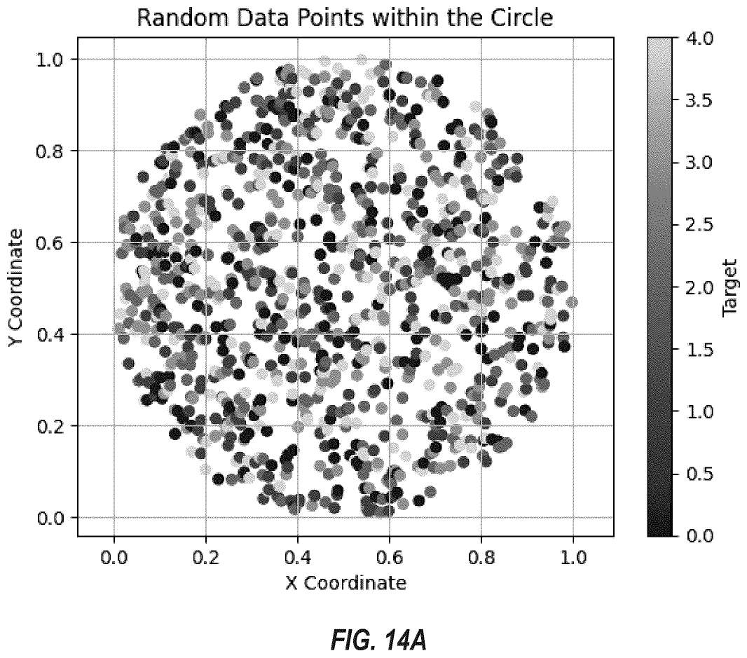

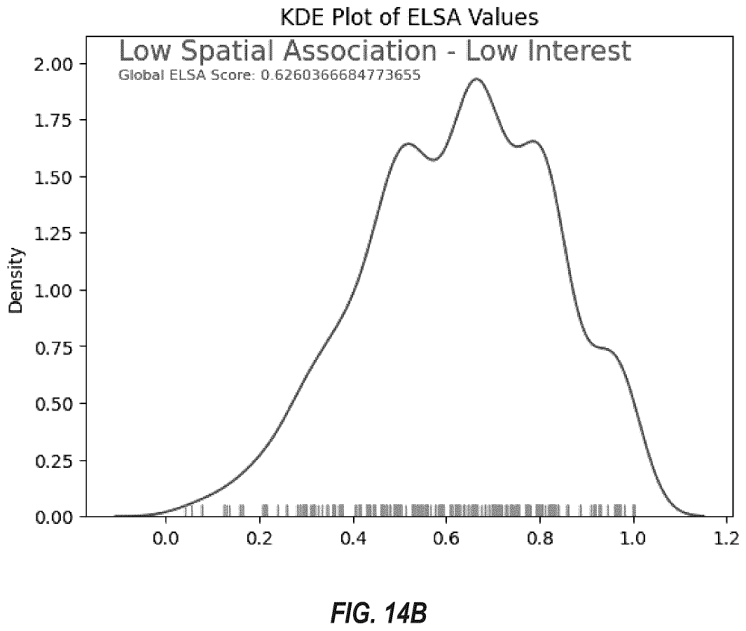

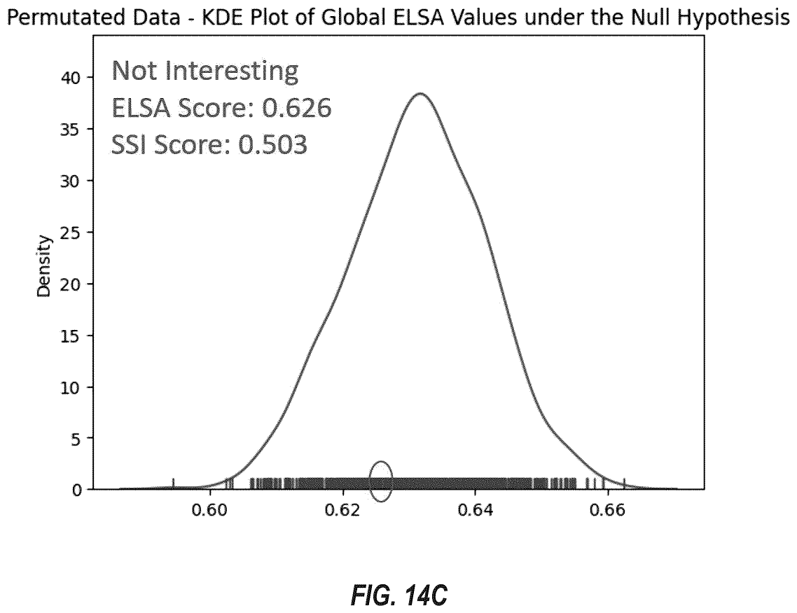

FIG. 14A illustrates a 2D representation of synthetic dimensionality-reduced dataset (referred to herein as “Dataset 14”) that comprises random data points within a circle. FIG. 13B illustrates a KDE plot of the spatial autocorrelation values associated with Dataset 14. FIG. 14B indicates that the global spatial autocorrelation score for Dataset 14 is 0.620366684773655, which indicates that Dataset 14 is likely irrelevant. FIG. 14C illustrates a KDE plot of spatial autocorrelation values associated with a permutated dataset based on Dataset 14. FIG. 13C plots the global spatial autocorrelation score for Dataset 14 (with a red marker and circle), illustrating that the global spatial autocorrelation score for Dataset 14 is similar to the mean of the spatial autocorrelation values for the permutated dataset based on Dataset 14. FIG. 14C also indicates the Z-score of 0.503 for Dataset 14 (e.g., corresponding to Z-score(s) 1216), also indicating that Dataset 14 is likely irrelevant.

In some cases, where a dimensionality-reduced dataset comprises class imbalance and/or high data uniformity, spatial autocorrelation data alone can fail to accurately indicate whether a dimensionality-reduced dataset is relevant. The contribution of the Z-score(s) 1216 to the relevance score(s) 1214 can contribute to accurate determination of the relevance of a dimensionality-reduced dataset(s) 1207 where class imbalance and/or high data uniformity are present.

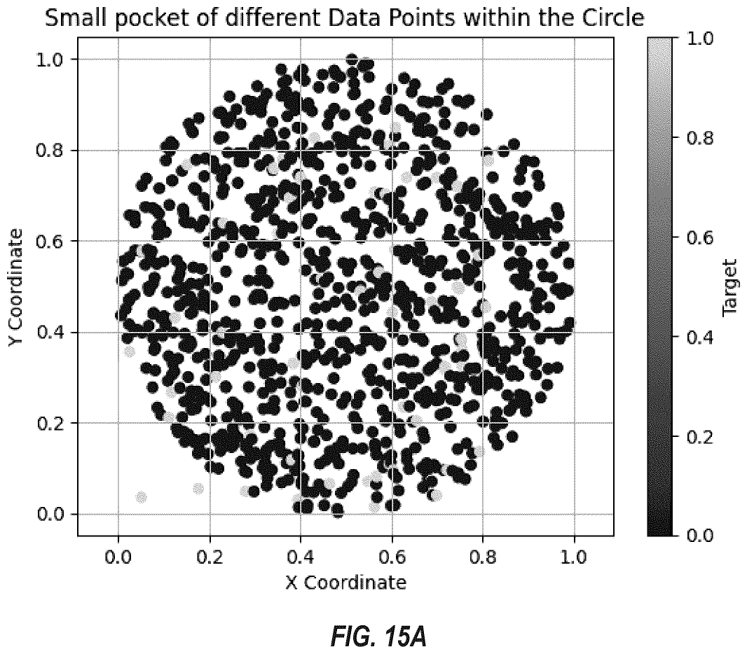

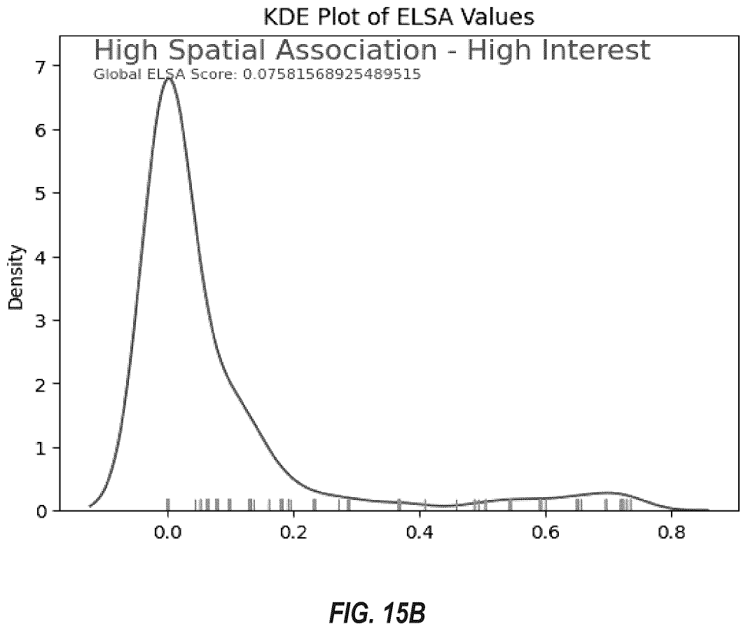

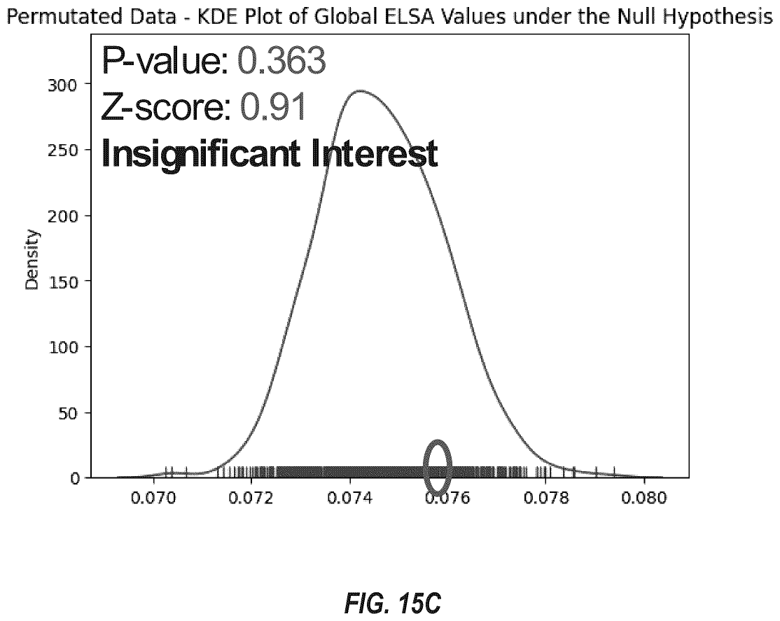

FIG. 15A illustrates a 2D representation of a synthetic dimensionality-reduced dataset (referred to herein as “Dataset 15”) that exhibits class imbalance with one of the classes having a small quantity of data points randomly positioned throughout the plot. FIG. 15B illustrates a KDE plot of the spatial autocorrelation values associated with Dataset 15. FIG. 15B indicates that the global spatial autocorrelation score for Dataset 15 is 0.07581568925489515, which indicates that Dataset 15 is likely relevant. However, as is evident from FIG. 15A, this representation of Dataset 15 is unlikely to readily convey data trends and/or relationships, due to the spatial randomness of the data. FIG. 15C illustrates a KDE plot of spatial autocorrelation values associated with a permutated dataset based on Dataset 15. FIG. 15C plots the global spatial autocorrelation score for Dataset 15 (with a red marker and a circle), illustrating that the global spatial autocorrelation score for Dataset 15 is similar to the mean of the spatial autocorrelation values for the permutated dataset based on Dataset 15. FIG. 15C also indicates the Z-score of 0.91 for Dataset 15 (e.g., corresponding to Z-score(s) 1216), indicating that Dataset 15 is likely irrelevant (in contrast to the suggestion of the spatial autocorrelation data alone for Dataset 15 as represented in FIG. 15B).

Continuing with the above example referring to a particular relevance score 1214 associated with a particular dimensionality-reduced dataset 1207, the particular pattern strength 1218 may be determined using the spatial analysis output 1212. For example, the corresponding spatial analysis output 1212 for the particular dimensionality-reduced dataset 1207 can include one or more matrices of spatial autocorrelation values, from which eigenvalue distribution(s) 1224 may be determined. Where the corresponding spatial analysis output 1212 for the particular dimensionality-reduced dataset 1207 includes a separate autocorrelation value matrix for each point represented in the particular dimensionality-reduced dataset 1207, the various matrices may be aggregated (e.g., averaged). The eigenvalue distribution 1224 for the particular dimensionality-reduced dataset 1207 may then be determined using the aggregated matrix. The eigenvalue distribution(s) 1224 can be determined using any techniques known in the art and can provide information about the spread and/or relationships (e.g., in neighborhoods) of the original variables represented in the corresponding spatial analysis output 1212 (e.g., similar to the mechanism used in principal component analysis (PCA) to measure explained variance). In some implementations, the eigenvalue distribution(s) 1224 is/are normalized such that the sum of the eigenvalues is equal to 1 (or another value).

FIG. 12 conceptually depicts additional eigenvalue distributions, including a noise eigenvalue distribution 1226 and a uniformity eigenvalue distribution 1228. The noise eigenvalue distribution 1226 can be generated based on a synthetic autocorrelation matrix that represents noisy data (e.g., an autocorrelation matrix where all values are 0 using Moran's Statistic, or where all values are 0.65 using ELSA), causing the noise eigenvalue distribution 1226 to be uniform (e.g., where every principal component explains the same amount of small variance). The uniformity eigenvalue distribution 1228 can be generated based on a synthetic autocorrelation matrix that represents uniform data (e.g., an autocorrelation matrix where all values are 1 using Moran's Statistic, or where all values are 0 using ELSA), causing the uniformity eigenvalue distribution 1228 to include a single principal component that explains all variance (where all other values are 0).

FIG. 12 conceptually depicts difference measure(s) 1230, which indicate difference between the eigenvalue distribution(s) 1224 (derived from the spatial analysis output 1212) and the noise eigenvalue distribution 1226. FIG. 12 furthermore depicts difference measure(s) 1232, which indicate difference between the eigenvalue distribution(s) 1224 and the uniformity eigenvalue distribution 1228. In one implementation, the difference measure(s) 1230 and 1232 can be measured as Kullback-Leibler (KL) divergences, such as by:

$$K L ( A ‖ B ) = \sum {a}_{i} ( x ) log ( \frac{{a}_{i} ( x )}{{b}_{i} ( x )} ) \qquad ( 2 )$$

for discrete distributions, or by:

$$K L ( A ‖ B ) = \int {a}_{i} ( x ) log ( \frac{{a}_{i} ( x )}{{b}_{i} ( x )} ) dx \qquad ( 3 )$$

for continuous distributions, where A represents a first distribution and where B represents a second distribution being compared. Other types of difference measures may be used to quantify the difference or deviation between the eigenvalue distribution(s) 1224 and the noise eigenvalue distribution 1226 and/or the uniformity eigenvalue distribution 1228.

The difference measure(s) 1230 and 1232 may be used to determine the pattern strength 1218 for the relevance score(s) 1214, as indicated in FIG. 12 by the arrows extending from the difference measure(s) 1230 and 1232 toward the pattern strength 1218. For example, the pattern strength 1218 may be obtained by determining an exponentiation of the difference between the difference measure(s) 1230 and 1232 (e.g., KL divergences), which may provide a likelihood ratio test statistic. In some implementations, the likelihood ratio test statistic follows a chi-squared distribution. In such a case, the pattern strength 1218 may be determined as the deviance of the likelihood test statistic from the mean of the chi-squared distribution (e.g., the number of degrees of freedom of the chi-squared distribution, which may be 1). Under this framework, how well datapoints of the dimensionality-reduced dataset(s) 1207 (e.g., aggregate and/or individual datapoints) fit a noise profile or a uniformity profile may be assessed via a two-tailed goodness-of-fit test at some confidence level (e.g., 95%). By way of illustrative example, the pattern strength 1218 (P_{S}) may be obtained by:

$${P}_{S} = 2 * ( - log ( λ ) + λ - k ) \qquad ( 4 )$$

where λ represents the likelihood ratio test statistic noted above, and where k represents the mean of the chi-squared distribution followed by λ (e.g., 1). In one example, λ is given by:

$$λ = \int log ( \frac{q ( x )}{{p}_{0} ( x )} ) q ( x ) dx - \int log ( \frac{q ( x )}{{p}_{1} ( x )} ) q ( x ) dx \qquad ( 5 )$$

where q represents an eigenvalue distribution 1224, p₀ represents the noise eigenvalue distribution 1226, and p₁ represents a uniformity eigenvalue distribution 1228.

In some implementations, the relevance score(s) 1214 is/are determined as a ratio of the Z-score(s) 1216 and the pattern strength 1218. For example, a particular relevance score 1214 (RS) for a particular dimensionality-reduced dataset 1207 (or a particular embedding) may be determined as a ratio of the sum of squared Z-scores 1216 and the pattern strength 1218, such as via:

$$RS = log ( \frac{‖ Z ‖}{{P}_{s}} ) \qquad ( 6 )$$

$$or via :$$

$$R S = log ( \frac{{\sum }_{i} {( \frac{{x}_{i} - {μ}_{i}}{{σ}_{i}} )}^{2}}{2 * ( - log ( λ ) + λ - 1 )} ) \qquad ( 7 )$$

where the mean of the chi-squared distribution followed by λ is equal to 1, and where a log of the ratio is taken for numerical precision. Intuitively, in this example, the z-score(s) 1216 operates as the numerator for the relevance score(s) 1214, which quantifies how far the particular dimensionality-reduced dataset 1207 deviates from spatial randomness (e.g., via a hypothesis testing technique that uses spatial randomness as the null hypothesis). The pattern strength 1218 operates as the denominator for the relevance score(s) 1214, which measures the strength of the patterns present in the particular dimensionality-reduced dataset 1207 across the embedding space (e.g., by determining the balance between complete noise and complete uniformity as defined by their eigenvalue distributions).

The relevance score(s) 1214 for the dimensionality-reduced dataset(s) 1207 (or for specific point clusters with specific data dimensions selected) can enable identification of which particular dimensionality-reduced dataset(s) 1207 and/or 3D representation(s) 1208 (or for specific point clusters with specific data dimensions thereof) is/are most likely to be beneficially interpretable by users to identify relationships and/or correlations among aspects/variables of the input dataset 1202. The relevance score(s) 1214 can provide a basis for generating a report 1240 that identifies particular dimensionality-reduced dataset(s) 1207 and/or 3D representation(s) 1208 (or particular point clusters with specific data dimensions selected) for further analysis by users. In one example, the report 1240 comprises a sortable list of dimensionality-reduced datasets 1207 and/or 3D representations 1208 (or specific point clusters with specific data dimensions selected) that can be presented on a user interface frontend, enabling the user to sort, identify, and/or select dimensionality-reduced datasets 1207 and/or 3D representations 1208 (or specific point clusters with specific data dimensions selected) with the highest relevance score(s) (overall or cluster-level relevance scores) for further analysis (e.g., via a data analysis interface 200). In some instances, the data analysis system 1200 directly loads or identifies dimensionality-reduced datasets 1207 and/or 3D representations 1208 (or specific point clusters with specific data dimensions selected) within a data analysis interface 200 (or any user interface frontend executable on any device, such as a system 2000) for assessment by the user based on the relevance score(s) 1214 (e.g., based on the relevance score(s) 1214 satisfying one or more threshold relevance values, which can comprise overall threshold relevance values for entire dimensionality-reduced datasets or 3D representations or point cluster-level threshold relevance values).

In some implementations the parameters 1206 used to generate the dimensionality-reduced dataset(s) 1207 with relevance score(s) 1214 that satisfy the threshold relevance value(s) are utilized to optimize parameters for dimensionality reduction modules for processing of future input datasets. In some implementations, a data analysis system 1200 initially processes an input dataset 1202 using a dimensionality reduction module 1204 with initial parameters 1206 to obtain a dimensionality-reduced dataset 1207, which is then subjected to spatial analysis, hypothesis testing (e.g., to obtain Z-score(s) 1216), and eigenvalue distribution divergence calculation (e.g., to obtain pattern strength 1218) to obtain relevance score(s) 1214. The data analysis system 1200 can then analyze the relevance score(s) 1214 and perform parameter autotuning 1250 (see FIG. 12) to modify the parameters 1206 for the dimensionality reduction module 1204 to re-process the input dataset 1202 to obtain updated relevance score(s) 1214. Such a process of generating relevance score(s) 1214 and performing parameter autotuning 1250 may be iterated until the relevance score(s) 1214 satisfy a relevance threshold (or another stop condition is satisfied), at which point a report 1240 may be generated for review by a user.

In some implementations, the relevance scoring framework for dimensionality-reduced datasets enables tuning of dimensionality reduction module parameters (or hyperparameters) for generating dimensionality-reduced datasets, which can result in a set of dimensionality-reduced representations for further analysis by users. For instance, a system may initialize a set of parameters for a dimensionality reduction module from a predefined search space utilizing a parameter search module (e.g., grid search, random search, grid random search, Bayesian optimization, genetic algorithms, particle swarm optimization, simulated annealing, metaheuristic optimization algorithms, exhaustive search, and/or others). The system may then generate a set of dimensionality-reduced datasets by processing an input dataset with the dimensionality reduction module using the set of parameters. The system may then perform spatial analysis on the set of dimensionality-reduced datasets (or sets of components thereof, such as sets of point clusters) and determine one or more relevance scores for the set of dimensionality-reduced datasets (or the sets of components thereof) using techniques described hereinabove with reference to FIG. 12. The system may then update the set of parameters for the dimensionality reduction module based on an evaluation of the relevance score(s) for the set of dimensionality-reduced datasets (or the sets of components thereof). The evaluation of the relevance score(s) can take on various forms, such as identifying relevance score(s) that satisfy one or more conditions (e.g., one or more thresholds) and using the identified relevance score(s) as a basis for updating the set of parameters. The system may iterate the steps of generating sets of dimensionality-reduced datasets from the input dataset using the updated set of parameters, performing spatial analysis, determining relevance scores, and updating the set of parameters based on an evaluation of the relevance scores until a stop condition is satisfied (e.g., performance of a predetermined number of iterations or epochs, detecting performance degradation, plateau detection, detecting relevance score(s) or changes in relevance score(s) with certain characteristics, and/or other conditions). When the stop condition is satisfied, the system can output a set of final parameters for the dimensionality reduction module, which can then be used to process the input dataset to generate a final set of dimensionality-reduced datasets and/or representations (e.g., for use in a report, for presentation on a user interface frontend, etc.).

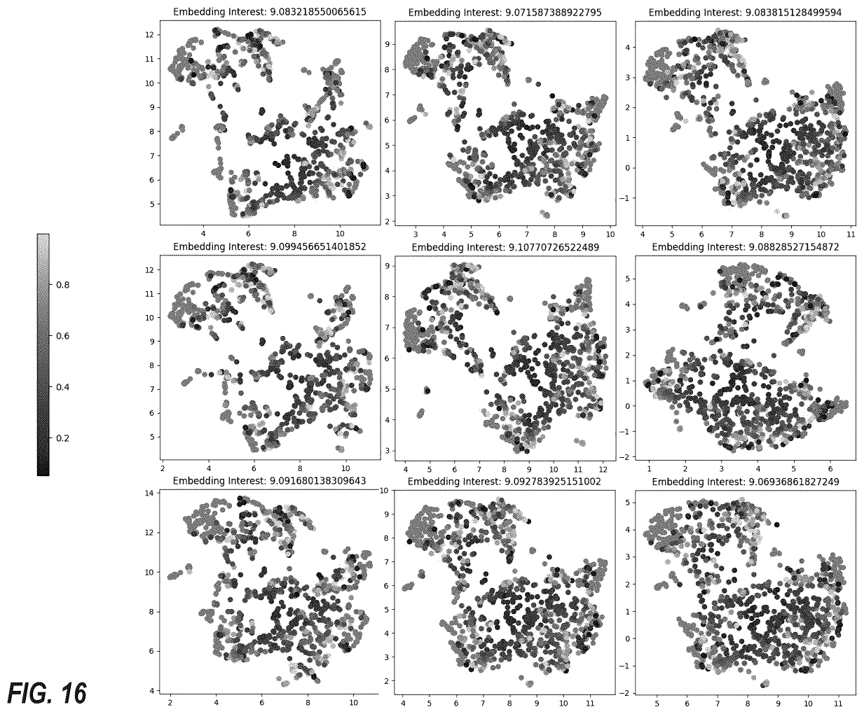

FIG. 16 illustrates a conceptual example of multiple embeddings (or dimensionality-reduced datasets) iteratively generated via UMAP using different UMAP parameters to search for a set of UMAP parameters that yields an embedding with a highest relevance score. The colors of the embedding points shown in FIG. 16 correspond to different p-values, where higher p-values indicate strong patterns within local neighborhoods, and where lower p-values indicate weak patterns within local neighborhoods. In the example shown, the UMAP parameters of “neighbors” (or “n_neighbors”) and “min_dist” are varied to obtain the different embeddings. In FIG. 16, the top row of embeddings is generated with min_dist set to 0.0, the middle row of embeddings is generated with min_dist set to 0.01, and the bottom row of embeddings is generated with min_dist set to 0.1. Furthermore, in FIG. 16, the left column of embeddings is generated with neighbors set to 16, the middle column of embeddings is generated with neighbors set to 43, and the right column of embeddings is generated with neighbors set to 96. The relevance scores for the various embeddings are labeled in FIG. 16 as “Embedding Interest”. In the example shown in FIG. 16, the middle embedding, generated with neighbors set to 43 and with min_dist set to 0.01, includes the highest relevance score of 9.10770726522489 (which is emphasized in FIG. 16 with a bounding box surrounding the relevance score).

### Example Method(s)

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed. The various acts/operations described herein may be performed using one or more components of one or more systems 2000 (described hereinafter).

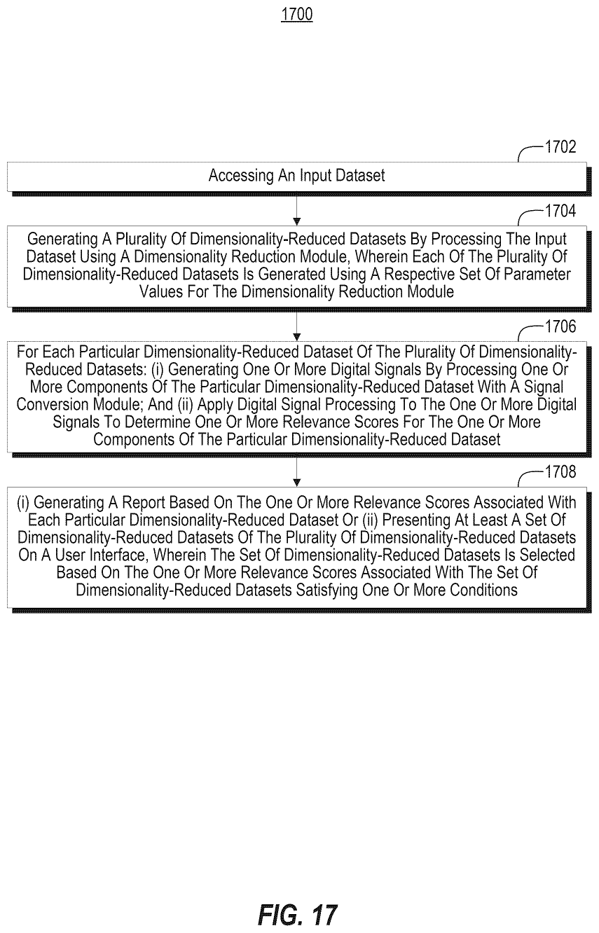

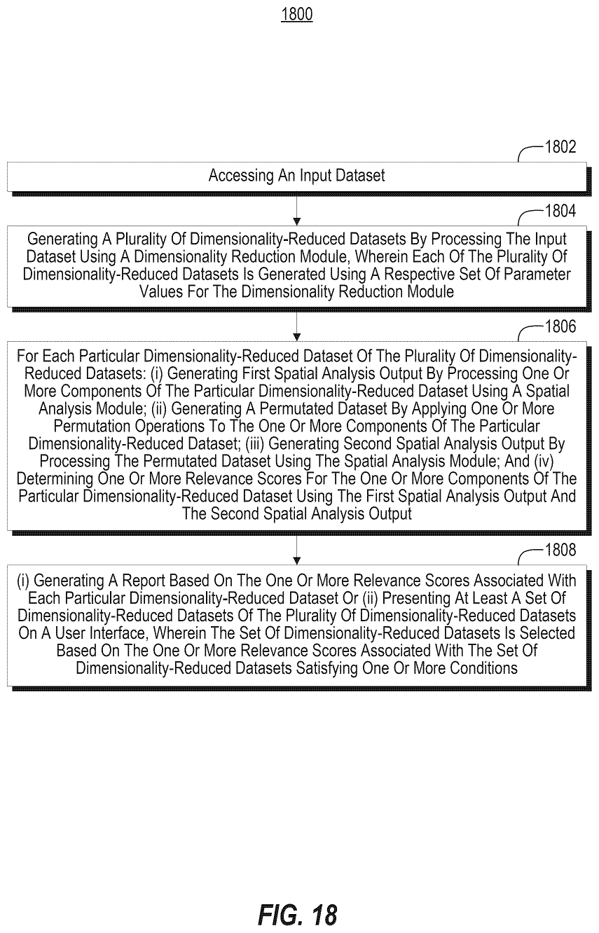

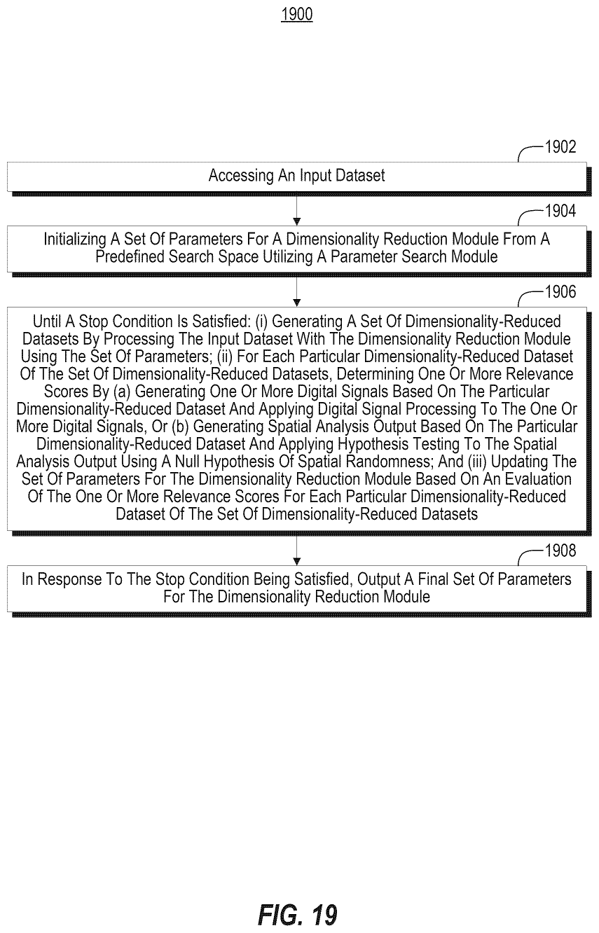

FIGS. 17, 18, and 19 illustrate example flow diagrams 1700, 1800, and 1900, respectively, depicting acts associated with facilitating analysis of dimensionality-reduced data.

Act 1702 of flow diagram 1700 includes accessing an input dataset.

Act 1704 of flow diagram 1700 includes generating a plurality of dimensionality-reduced datasets by processing the input dataset using a dimensionality reduction module, wherein each of the plurality of dimensionality-reduced datasets is generated using a respective set of parameter values for the dimensionality reduction module. In some instances, the dimensionality reduction module comprises a uniform manifold approximation and projection (UMAP) module.

Act 1706 of flow diagram 1700 includes, for each particular dimensionality-reduced dataset of the plurality of dimensionality-reduced datasets: (i) generating one or more digital signals by processing one or more components of the particular dimensionality-reduced dataset with a signal conversion module; and (ii) apply digital signal processing to the one or more digital signals to determine one or more relevance scores for the one or more components of the particular dimensionality-reduced dataset. In some implementations, applying digital signal processing to the one or more digital signals comprises applying a Fourier transform to the one or more digital signals and determining a signal-to-noise ratio based on output of the Fourier transform. In some embodiments, the one or more relevance scores are based on a disparity between a noise floor and a peak amplitude of the signal-to-noise ratio.

Act 1708 of flow diagram 1700 includes (i) generating a report based on the one or more relevance scores associated with each particular dimensionality-reduced dataset or (ii) presenting at least a set of dimensionality-reduced datasets of the plurality of dimensionality-reduced datasets on a user interface, wherein the set of dimensionality-reduced datasets is selected based on the one or more relevance scores associated with the set of dimensionality-reduced datasets satisfying one or more conditions. In some examples, the one or more conditions comprise the one or more relevance scores of the set of dimensionality-reduced datasets satisfying one or more threshold relevance values. In some instances, the report (a) sorts at least a subset of dimensionality-reduced datasets of the plurality of dimensionality-reduced datasets based on the one or more relevance scores of the subset of dimensionality-reduced datasets or (b) identifies a subset of dimensionality-reduced datasets of the plurality of dimensionality-reduced datasets for which the one or more relevance scores satisfy one or more conditions.

Act 1802 of flow diagram 1800 includes accessing an input dataset. In some implementations, the input dataset comprises data with continuous features. In some embodiments, the input dataset comprises data with categorical features.

Act 1804 of flow diagram 1800 includes generating a plurality of dimensionality-reduced datasets by processing the input dataset using a dimensionality reduction module, wherein each of the plurality of dimensionality-reduced datasets is generated using a respective set of parameter values for the dimensionality reduction module. In some examples, the dimensionality reduction module comprises a uniform manifold approximation and projection (UMAP) module.

Act 1806 of flow diagram 1800 includes, for each particular dimensionality-reduced dataset of the plurality of dimensionality-reduced datasets: (i) generating first spatial analysis output by processing one or more components of the particular dimensionality-reduced dataset using a spatial analysis module; (ii) generating a permutated dataset by applying one or more permutation operations to the one or more components of the particular dimensionality-reduced dataset; (iii) generating second spatial analysis output by processing the permutated dataset using the spatial analysis module; and (iv) determining one or more relevance scores for the one or more components of the particular dimensionality-reduced dataset using the first spatial analysis output and the second spatial analysis output. In some instances, the spatial analysis module comprises a spatial autocorrelation module. In some implementations, the spatial autocorrelation module comprises a Moran's Statistic spatial autocorrelation module. In some embodiments, the spatial autocorrelation module comprises an exact local spatial autocorrelation (ELSA) module. In some examples, applying the one or more permutation operations to the one or more components of the particular dimensionality-reduced dataset causes the permutated dataset to at least partially embody spatial randomness. In some instances, the one or more relevance scores for the one or more components of the particular dimensionality-reduced dataset are based on one or more z-scores determined using (i) spatial autocorrelation values from the first spatial analysis output, (ii) a mean spatial autocorrelation value from the second spatial analysis output, and (iii) a standard deviation spatial autocorrelation value from the second spatial analysis output. In some implementations, the one or more relevance scores for the one or more components of the particular dimensionality-reduced dataset are based on one or more pattern strength metrics determined using (i) one or more first difference measures indicating difference between (a) one or more eigenvalue distributions determined from the first spatial analysis output and (b) one or more noise eigenvalue distributions associated with data noise and (ii) one or more second difference measures indicating difference between (a) the one or more eigenvalue distributions determined from the first spatial analysis output and (b) one or more uniformity eigenvalue distributions associated with data uniformity. In some embodiments, the one or more pattern strength metrics are determined as a deviance of a likelihood ratio test statistic from a mean of a chi-squared distribution that the likelihood ratio test statistic follows, wherein the likelihood ratio test statistic is determined based on an exponentiation of a difference between the one or more first difference measures and the one or more second difference measures.

Act 1808 of flow diagram 1800 includes (i) generating a report based on the one or more relevance scores associated with each particular dimensionality-reduced dataset or (ii) presenting at least a set of dimensionality-reduced datasets of the plurality of dimensionality-reduced datasets on a user interface, wherein the set of dimensionality-reduced datasets is selected based on the one or more relevance scores associated with the set of dimensionality-reduced datasets satisfying one or more conditions. In some examples, the one or more conditions comprise the one or more relevance scores of the set of dimensionality-reduced datasets satisfying one or more threshold relevance values. In some, instances, the report (a) sorts at least a subset of dimensionality-reduced datasets of the plurality of dimensionality-reduced datasets based on the one or more relevance scores of the subset of dimensionality-reduced datasets or (b) identifies a subset of dimensionality-reduced datasets of the plurality of dimensionality-reduced datasets for which the one or more relevance scores satisfy one or more conditions.

Act 1902 of flow diagram 1900 includes accessing an input dataset.

Act 1904 of flow diagram 1900 includes initializing a set of parameters for a dimensionality reduction module from a predefined search space utilizing a parameter search module.

Act 1906 of flow diagram 1900 includes, until a stop condition is satisfied: (i) generating a set of dimensionality-reduced datasets by processing the input dataset with the dimensionality reduction module using the set of parameters; (ii) for each particular dimensionality-reduced dataset of the set of dimensionality-reduced datasets, determining one or more relevance scores by (a) generating one or more digital signals based on the particular dimensionality-reduced dataset and applying digital signal processing to the one or more digital signals, or (b) generating spatial analysis output based on the particular dimensionality-reduced dataset and applying hypothesis testing to the spatial analysis output using a null hypothesis of spatial randomness; and (iii) updating the set of parameters for the dimensionality reduction module based on an evaluation of the one or more relevance scores for each particular dimensionality-reduced dataset of the set of dimensionality-reduced datasets.

Act 1908 of flow diagram 1900 includes, in response to the stop condition being satisfied, output a final set of parameters for the dimensionality reduction module.

### Additional Details Related to Implementing the Disclosed Embodiments

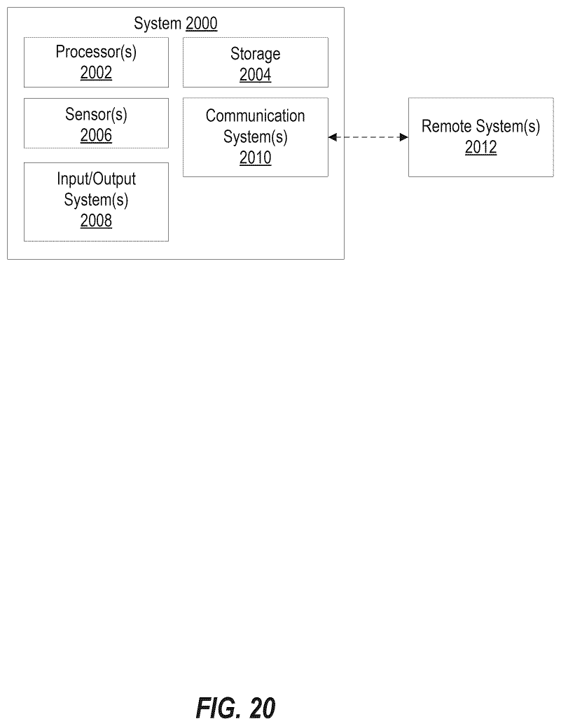

FIG. 20 illustrates example components of a system 2000 that may comprise or implement aspects of one or more disclosed embodiments. For example, FIG. 20 illustrates an implementation in which the system 2000 includes processor(s) 2002, storage 2004, sensor(s) 2006, I/O system(s) 2008, and communication system(s) 2010. Although FIG. 20 illustrates a system 2000 as including particular components, one will appreciate, in view of the present disclosure, that a system 2000 may comprise any number of additional or alternative components.

The processor(s) 2002 may comprise one or more sets of electronic circuitries that include any number of logic units, registers, and/or control units to facilitate the execution of computer-readable instructions (e.g., instructions that form a computer program). Such computer-readable instructions may be stored within storage 2004. The storage 2004 may comprise physical system memory and may be volatile, non-volatile, or some combination thereof. Furthermore, storage 2004 may comprise local storage, remote storage (e.g., accessible via communication system(s) 2010 or otherwise), or some combination thereof. Additional details related to processors (e.g., processor(s) 2002) and computer storage media (e.g., storage 2004) will be provided hereinafter.

As will be described in more detail, the processor(s) 2002 may be configured to execute instructions stored within storage 2004 to perform certain actions. In some instances, the actions may rely at least in part on communication system(s) 2010 for receiving data from remote system(s) 2012, which may include, for example, separate systems or computing devices, sensors, and/or others. The communications system(s) 2010 may comprise any combination of software or hardware components that are operable to facilitate communication between on-system components/devices and/or with off-system components/devices. For example, the communications system(s) 2010 may comprise ports, buses, or other physical connection apparatuses for communicating with other devices/components. Additionally, or alternatively, the communications system(s) 2010 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 20 illustrates that a system 2000 may comprise or be in communication with sensor(s) 2006. Sensor(s) 2006 may comprise any device for capturing or measuring data representative of perceivable phenomenon. By way of non-limiting example, the sensor(s) 2006 may comprise one or more image sensors, microphones, thermometers, barometers, magnetometers, accelerometers, gyroscopes, and/or others.

Furthermore, FIG. 20 illustrates that a system 2000 may comprise or be in communication with I/O system(s) 2008. I/O system(s) 2008 may include any type of input or output device such as, by way of non-limiting example, a display, a touch screen, a mouse, a keyboard, a controller, and/or others, without limitation.

Disclosed embodiments may comprise or utilize a special purpose or general-purpose computer including computer hardware, as discussed in greater detail below. Disclosed embodiments also include physical and other computer-readable recording media for carrying or storing computer-executable instructions and/or data structures. Such computer-readable recording media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable recording media, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of wired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for facilitating analysis of dimensionality-reduced data, comprising:
one or more processors; and
one or more computer-readable recording media that store instructions that are executable by the one or more processors to configure the system to:
access an input dataset;
generate a plurality of dimensionality-reduced datasets by processing the input dataset using a dimensionality reduction module, wherein each of the plurality of dimensionality-reduced datasets is generated using a respective set of parameter values for the dimensionality reduction module;
for each particular dimensionality-reduced dataset of the plurality of dimensionality-reduced datasets:
generate one or more digital signals by processing one or more components of the particular dimensionality-reduced dataset with a signal conversion module; and
apply digital signal processing to the one or more digital signals to determine one or more relevance scores for the one or more components of the particular dimensionality-reduced dataset; and
(i) generate a report based on the one or more relevance scores associated with each particular dimensionality-reduced dataset or (ii) present at least a set of dimensionality-reduced datasets of the plurality of dimensionality-reduced datasets on a user interface, wherein the set of dimensionality-reduced datasets is selected based on the one or more relevance scores associated with the set of dimensionality-reduced datasets satisfying one or more conditions.

2. The system of claim 1, wherein the dimensionality reduction module comprises a uniform manifold approximation and projection (UMAP) module.

3. The system of claim 1, wherein applying digital signal processing to the one or more digital signals comprises applying a Fourier transform to the one or more digital signals and determining a signal-to-noise ratio based on output of the Fourier transform.

4. The system of claim 3, wherein the one or more relevance scores are based on a disparity between a noise floor and a peak amplitude of the signal-to-noise ratio.

5. The system of claim 1, wherein the instructions are executable by the one or more processors to configure the system to generate the report based on the one or more relevance scores associated with each particular dimensionality-reduced dataset.

6. The system of claim 5, wherein the one or more conditions comprise the one or more relevance scores of the set of dimensionality-reduced datasets satisfying one or more threshold relevance values.

7. The system of claim 5, wherein the report (a) sorts at least a subset of dimensionality-reduced datasets of the plurality of dimensionality-reduced datasets based on the one or more relevance scores of the subset of dimensionality-reduced datasets or (b) identifies a subset of dimensionality-reduced datasets of the plurality of dimensionality-reduced datasets for which the one or more relevance scores satisfy one or more conditions.

8. A system for facilitating analysis of dimensionality-reduced data, comprising:
one or more processors; and
one or more computer-readable recording media that store instructions that are executable by the one or more processors to configure the system to:
access an input dataset;
generate a plurality of dimensionality-reduced datasets by processing the input dataset using a dimensionality reduction module, wherein each of the plurality of dimensionality-reduced datasets is generated using a respective set of parameter values for the dimensionality reduction module;
for each particular dimensionality-reduced dataset of the plurality of dimensionality-reduced datasets:
generate first spatial analysis output by processing one or more components of the particular dimensionality-reduced dataset using a spatial analysis module;
generate a permutated dataset by applying one or more permutation operations to the one or more components of the particular dimensionality-reduced dataset;
generate second spatial analysis output by processing the permutated dataset using the spatial analysis module; and
determine one or more relevance scores for the one or more components of the particular dimensionality-reduced dataset using the first spatial analysis output and the second spatial analysis output; and
(i) generate a report based on the one or more relevance scores associated with each particular dimensionality-reduced dataset or (ii) present at least a set of dimensionality-reduced datasets of the plurality of dimensionality-reduced datasets on a user interface, wherein the set of dimensionality-reduced datasets is selected based on the one or more relevance scores associated with the set of dimensionality-reduced datasets satisfying one or more conditions.

9. The system of claim 8, wherein the dimensionality reduction module comprises a uniform manifold approximation and projection (UMAP) module.

10. The system of claim 8, wherein the spatial analysis module comprises a spatial autocorrelation module.

11. The system of claim 10, wherein the input dataset comprises data with continuous features, and wherein the spatial autocorrelation module comprises a Moran's Statistic spatial autocorrelation module.

12. The system of claim 10, wherein the input dataset comprises data with categorical features, and wherein the spatial autocorrelation module comprises an exact local spatial autocorrelation (ELSA) module.

13. The system of claim 10, wherein applying the one or more permutation operations to the one or more components of the particular dimensionality-reduced dataset causes the permutated dataset to at least partially embody spatial randomness.

14. The system of claim 13, wherein the one or more relevance scores for the one or more components of the particular dimensionality-reduced dataset are based on one or more z-scores determined using (i) spatial autocorrelation values from the first spatial analysis output, (ii) a mean spatial autocorrelation value from the second spatial analysis output, and (iii) a standard deviation spatial autocorrelation value from the second spatial analysis output.

15. The system of claim 14, wherein the one or more relevance scores for the one or more components of the particular dimensionality-reduced dataset are based on one or more pattern strength metrics determined using (i) one or more first difference measures indicating difference between (a) one or more eigenvalue distributions determined from the first spatial analysis output and (b) one or more noise eigenvalue distributions associated with data noise and (ii) one or more second difference measures indicating difference between (a) the one or more eigenvalue distributions determined from the first spatial analysis output and (b) one or more uniformity eigenvalue distributions associated with data uniformity.

16. The system of claim 15, wherein the one or more pattern strength metrics are determined as a deviance of a likelihood ratio test statistic from a mean of a chi-squared distribution that the likelihood ratio test statistic follows, wherein the likelihood ratio test statistic is determined based on an exponentiation of a difference between the one or more first difference measures and the one or more second difference measures.

17. The system of claim 8, wherein the instructions are executable by the one or more processors to configure the system to generate the report based on the one or more relevance scores associated with each particular dimensionality-reduced dataset.

18. The system of claim 17, wherein the one or more conditions comprise the one or more relevance scores of the set of dimensionality-reduced datasets satisfying one or more threshold relevance values.

19. The system of claim 17, wherein the report (a) sorts at least a subset of dimensionality-reduced datasets of the plurality of dimensionality-reduced datasets based on the one or more relevance scores of the subset of dimensionality-reduced datasets or (b) identifies a subset of dimensionality-reduced datasets of the plurality of dimensionality-reduced datasets for which the one or more relevance scores satisfy one or more conditions.

20. A system for facilitating analysis of dimensionality-reduced data, comprising:
one or more processors; and
one or more computer-readable recording media that store instructions that are executable by the one or more processors to configure the system to:
access an input dataset;
initialize a set of parameters for a dimensionality reduction module from a predefined search space utilizing a parameter search module;
until a stop condition is satisfied:
generate a set of dimensionality-reduced datasets by processing the input dataset with the dimensionality reduction module using the set of parameters;
for each particular dimensionality-reduced dataset of the set of dimensionality-reduced datasets, determine one or more relevance scores by (i) generating one or more digital signals based on the particular dimensionality-reduced dataset and applying digital signal processing to the one or more digital signals, or (ii) generating spatial analysis output based on the particular dimensionality-reduced dataset and applying hypothesis testing to the spatial analysis output using a null hypothesis of spatial randomness; and
update the set of parameters for the dimensionality reduction module based on an evaluation of the one or more relevance scores for each particular dimensionality-reduced dataset of the set of dimensionality-reduced datasets; and
in response to the stop condition being satisfied, output a final set of parameters for the dimensionality reduction module.
